(19) United States
(12) Patent Application Publication
(10) Pub. No.: US 2026/0275467 A1
(43) Pub. Date: Sep. 17, 2026

(54) GRAIN-ORIENTED ELECTRICAL STEEL SHEET AND MANUFACTURING METHOD OF GRAIN-ORIENTED ELECTRICAL STEEL SHEET

(71) Applicant: NIPPON STEEL CORPORATION, Tokyo (JP)

(72) Inventors: Haruhiko ATSUMI, Tokyo (JP); Ryutaro YAMAGATA, Tokyo (JP); Takashi KATAOKA, Tokyo (JP); Takaaki HIRAYAMA, Tokyo (JP); Tatsuhiko SAKAI, Tokyo (JP)

(73) Assignee: NIPPON STEEL CORPORATION, Tokyo (JP)

(21) Appl. No.: 19/473,439

(22) PCT Filed: Apr. 11, 2024
(86) PCT No.: PCT/JP2024/014697

§ 371 Date: Oct. 7, 2025

(30) Foreign Application Priority Data
Apr. 12, 2023 (JP) 2023-065018

(51) Int. Cl. C22C 38/02; C21D 6/00; C21D 8/1216; C21D 8/1244; C21D 8/1277; C21D 9/46; C22C 38/00; C22C 38/04; C22C 38/06; C22C 38/42; C22C 38/44; C22C 38/46; C22C 38/48; C22C 38/54; C22C 38/60

(52) U.S. Cl. CPC C22C 38/02; C21D 6/008; C21D 8/1222; C21D 8/1233; C21D 8/1255; C21D 8/1261; C21D 8/1272; C21D 8/1283; C21D 9/46; C22C 38/001; C22C 38/002; C22C 38/008; C22C 38/04; C22C 38/06; C22C 38/42; C22C 38/44; C22C 38/46; C22C 38/48; C22C 38/54; C22C 38/60; C21D 2201/05

(57) ABSTRACT

In the grain-oriented electrical steel sheet, when measurement points for crystal orientation by an X-ray diffraction method are arranged on a surface of a base steel sheet having a predetermined chemical composition at a pitch of 6 mm in each of a rolling direction and a direction orthogonal to the rolling direction, measurement points whose orientation difference from {211}<011> is within 15° are included in a percentage of 5% or less with respect to the total measurement points; in a line analysis along the rolling direction by an electron probe microanalyzer, an obtained oxygen intensity profile at a surface of the primary coating periodically includes a region having a reduced oxygen intensity; and Ioₘᵢₙ is defined as a minimum value of oxygen intensity in the region having a reduced oxygen intensity, Ioₘₐₓ is defined as a maximum value of oxygen intensity in a region other than the region having a reduced oxygen intensity, and a ratio of Ioₘᵢₙ/Ioₘₐₓ is 0.85 or more and 0.96 or less.

### TECHNICAL FIELD

The present invention relates to a grain-oriented electrical steel sheet and a manufacturing method of a grain-oriented electrical steel sheet.

Priority is claimed on Japanese Patent Application No. 2023-065018, filed Apr. 12, 2023, the content of which is incorporated herein by reference.

### BACKGROUND ART

A grain-oriented electrical steel sheet is a soft magnetic material, and is mainly used as a core material of a transformer. Thus, the grain-oriented electrical steel sheet is required to have magnetic characteristics such as high magnetization characteristics and a low iron loss. The iron loss is a power loss due to consumption as thermal energy that occurs when the iron core is excited by an AC magnetic field, and the iron loss is required to be as low as possible from the viewpoint of energy saving.

The iron loss is represented by the sum of hysteresis loss depending on crystal orientation, purity, and the like and eddy-current loss depending on sheet thickness, specific resistance, the size of magnetic domains, and the like. Therefore, in order to reduce the iron loss, it is effective to reduce the hysteresis loss and the eddy-current loss. As a method for reducing the hysteresis loss, a method is known in which the crystal orientation is developed into the Goss orientation ({110}<001> orientation), which is excellent in magnetic characteristics (orientation development degree is increased), to increase the magnetic flux density. As a method of reducing the eddy-current loss, a method is known in which the Si content is increased to enhance electric resistance, the sheet thickness of the steel sheet is reduced, and the magnetic domain is refined.

In particular, in the method of reducing the sheet thickness, cold rolling is often used. However, a grain-oriented electrical steel sheet having a thin sheet thickness has a problem that good magnetic characteristics cannot be stably obtained. For example, the following techniques are disclosed as a method for improving the magnetic characteristics of a grain-oriented electrical steel sheet having a thin sheet thickness.

Patent Document 1 discloses a manufacturing method of a grain-oriented electrical steel sheet in which cold rolling is performed two times with intermediate annealing interposed therebetween. Specifically, Patent Document 1 discloses that hot rolling is terminated at 850° C. or higher, the resultant is immediately cooled and wound at 600° C. or lower, and then a carbide-adjusting heat treatment including heat equalization in a temperature range of 650 to 900° C. for 2 to 10 seconds is performed prior to the first cold rolling. As a result, even a grain-oriented electrical steel sheet having a thin sheet thickness can stably obtain an excellent magnetic flux density in the longitudinal direction of the coil.

Patent Document 2 discloses a manufacturing method of a grain-oriented electrical steel sheet in which cold rolling is performed one time or two or more times with intermediate annealing interposed therebetween. Specifically, Patent Document 2 discloses that a strip having a final cold rolling reduction of 89% or more and rolled to the final sheet thickness is heat-treated to a temperature of 700° C. or higher at a heating rate of 50° C./s or higher immediately before decarburization annealing to obtain excellent magnetic flux density and iron loss.

### CITATION LIST

### Patent Documents

Patent Document 1: Japanese Unexamined Patent Application, First Publication No. H06-145799
Patent Document 2: Japanese Unexamined Patent Application, First Publication No. H07-62438

### SUMMARY OF INVENTION

### Technical Problem

However, in conventional techniques, the magnetic flux density may vary. In addition, when rapid heating is performed in the decarburization annealing step, adhesion between the steel sheet and the insulating coating (hereinafter, referred to as coating adhesion) may deteriorate.

An object of the present disclosure is to provide a grain-oriented electrical steel sheet excellent in magnetic properties and coating adhesion, and a manufacturing method thereof.

### Solution to Problem

The gist of the present disclosure is as follows.
[1] In an embodiment of the present disclosure, a grain-oriented electrical steel sheet includes: a base steel sheet; a primary coating formed on the base steel sheet; and a secondary coating formed on the primary coating, in which
   the base steel sheet includes, as a chemical composition, in terms of mass %,
   2.50 to 4.00% of Si,
   0.01 to 0.30% of Mn,
   0.0001 to 0.0100% of N,
   0.0005 to 0.010% of C,
   0 to 0.010% of sol. Al,
   0 to 0.010% in total of at least one selected from the group consisting of a group consisting of S and Se,
   0.001 to 0.010% of Ti,
   0 to 0.50% of Ni,
   0 to 0.50% of Cu,
   0 to 0.30% of Sb,
   0 to 0.30% of Sn,
   0 to 0.50% of Cr,
   0 to 0.05% of P,
   0 to 0.05% of Mo,
   0 to 0.05% of Ta,
   0 to 0.010% of Nb,
   0 to 0.50% of V,
   0 to 0.010% of B,
   0 to 0.0150% of Bi,
   0 to 0.0150% of Te, and
   a balance including Fe and impurities;
   the grain-oriented electrical steel sheet has a magnetic flux density B8 of 1.902 T or more,
   when measurement points for crystal orientation by an X-ray diffraction method are arranged on a surface of the base steel sheet at a pitch of 6 mm in each of a rolling direction and a direction orthogonal to the rolling direction, measurement points whose orientation difference from {211}<011> is within 15° are included in a percentage of 5% or less with respect to the total measurement points,
   in a line analysis along the rolling direction by an electron probe microanalyzer, an obtained oxygen intensity profile at a surface of the primary coating periodically includes a region having a reduced oxygen intensity, and
   Ioₘᵢₙ is defined as a minimum value of oxygen intensity in the region having a reduced oxygen intensity, Ioₘₐₓ is defined as a maximum value of oxygen intensity in a region other than the region having a reduced oxygen intensity, and a ratio of Ioₘᵢₙ/Ioₘₐₓ is 0.85 or more and 0.96 or less.
[2] In the grain-oriented electrical steel sheet according to [1], the region having a reduced oxygen intensity may be included at an interval L of 5 to 30 mm.
[3] In the grain-oriented electrical steel sheet according to [1] or [2], the base steel sheet may include, as the chemical composition, in terms of mass %, at least one selected from the group consisting of:
   0.01 to 0.50% of Ni,
   0.01 to 0.50% of Cu,
   0.01 to 0.30% of Sb,
   0.01 to 0.30% of Sn,
   0.01 to 0.50% of Cr,
   0.01 to 0.05% of P,
   0.01 to 0.05% of Mo,
   0.01 to 0.05% of Ta,
   0.001 to 0.010% of Nb,
   0.01 to 0.50% of V,
   0.001 to 0.010% of B,
   0.0100% or less of Bi, and
   0.0100% or less of Te.
[4] The grain-oriented electrical steel sheet according to any one of [1] to [3] may have a sheet thickness of 0.15 to 0.23 mm.
[5] In the grain-oriented electrical steel sheet according to any one of [1] to [4], the base steel sheet may have a sheet thickness of 0.14 to 0.22 mm.
[6] In an embodiment of the present disclosure, a manufacturing method of a grain-oriented electrical steel sheet includes:
   a hot rolling step of heating a slab and hot rolling the heated slab to obtain a hot-rolled steel sheet, the slab including, in terms of mass %,
   2.50 to 4.00% of Si,
   0.01 to 0.30% of Mn,
   0.0030 to 0.0150% of N,
   0.010 to 0.100% of C,
   0.010 to 0.050% of sol. Al,
   0.010 to 0.050% in total of at least one selected from the group consisting of a group consisting of S and Se,
   0.001 to 0.010% of Ti,
   0 to 0.50% of Ni,
   0 to 0.50% of Cu,
   0 to 0.30% of Sb,
   0 to 0.30% of Sn,
   0 to 0.50% of Cr,
   0 to 0.05% of P,
   0 to 0.05% of Mo,
   0 to 0.05% of Ta,
   0 to 0.010% of Nb,
   0 to 0.50% of V,
   0 to 0.010% of B,
   0 to 0.0200% of Bi,
   0 to 0.0200% of Te, and
   a balance including Fe and impurities;
   a hot-band annealing step of annealing the hot-rolled steel sheet;
   a cold rolling step of cold rolling the hot-rolled steel sheet after the hot-band annealing step to obtain a cold-rolled steel sheet;
   a decarburization annealing step of decarburization annealing the cold-rolled steel sheet to obtain a decarburization-annealed steel sheet;
   a final annealing step of applying an annealing separator on the decarburization-annealed steel sheet, followed by final annealing, to form a primary coating on a surface of the decarburization-annealed steel sheet, thereby obtaining a final-annealed steel sheet; and
   an insulating coating forming step of forming an insulating coating on a surface of the final-annealed steel sheet, in which
   a total rolling reduction is 89% or more in the cold rolling step,
   the decarburization annealing step includes:
      a local heating process of partly heating a surface of the cold-rolled steel sheet by irradiating with a laser beam in an air atmosphere at an interval of 5 to 30 mm in a direction that forms 30 to 150° with respect to a rolling direction;
      a temperature rising process of raising a temperature of the cold-rolled steel sheet after the local heating process in a non-oxidizing atmosphere from a temperature range of 450° C. or lower to a temperature range of 750 to 950° C., which is a temperature for decarburization annealing, at an average heating rate of 80° C./sec or more and 2000° C./sec or less; and
      a heat equalizing process of decarburization annealing the cold-rolled steel sheet after the temperature rising process at an oxygen potential P_{O} satisfying an equation (1) below,
   when, in irradiation conditions of the laser beam in the local heating process,
   an average intensity of the laser beam is defined as P, in terms of a unit of W,
   a focused spot diameter of a focused spot in the rolling direction is defined as Dl, in terms of a unit of mm,
   a focused spot diameter of the focused spot in a width direction orthogonal to the rolling direction is defined as Dc, in terms of a unit of mm,
   an irradiation time is defined as t, in terms of a unit of sec, and
   an instantaneous input energy represented by 4/π×P/(Dl×Dc)×t is defined as Up, in terms of a unit of J/mm²,
   an equation (2) below is satisfied:

$${P}_{O} \leq 0.6 - 0.04 Up \qquad ( 1 )$$

$$1 \leq Up \leq 5. \qquad ( 2 )$$

[7] In the manufacturing method of a grain-oriented electrical steel sheet according to [6], the slab may include, as the chemical composition, in terms of mass %, at least one selected from the group consisting of:
   0.01 to 0.50% of Ni,
   0.01 to 0.50% of Cu,
   0.01 to 0.30% of Sb,
   0.01 to 0.30% of Sn,
   0.01 to 0.50% of Cr,
   0.01 to 0.05% of P,
   0.01 to 0.05% of Mo,
   0.01 to 0.05% of Ta,
   0.001 to 0.010% of Nb,
   0.01 to 0.50% of V,
   0.001 to 0.010% of B,
   0.0100% or less of Bi, and
   0.0100% or less of Te.

### Advantageous Effects of Invention

According to the present disclosure, it is possible to provide a grain-oriented electrical steel sheet excellent in magnetic properties and coating adhesion, and a manufacturing method thereof.

### BRIEF DESCRIPTION OF DRAWINGS

FIG. 1 A view illustrating an example of a cold-rolled steel sheet in which linear heated parts are formed.

FIG. 2 A view illustrating the focused spot diameter and the scanning speed of a laser beam.

FIG. 3 A schematic diagram of an oxygen intensity profile measured by EPMA line analysis of the surface of a primary coating.

### DESCRIPTION OF EMBODIMENTS

### <1. Study by Present Inventors>

Hereinafter, an embodiment of the present invention will be described. First, studies conducted by the present inventors will be described. The present inventors have investigated why a grain-oriented electrical steel sheet deteriorates and varies in magnetic flux density. As a result, the deterioration of magnetic characteristics is caused by secondary recrystallized grains having a crystal orientation of {211}<011>, which is inferior in magnetic characteristics. In addition, it has been found that the magnetic characteristics vary in the longitudinal direction of the coil, and the magnetic characteristics remarkably deteriorate particularly in the end portion of the longitudinal direction of the coil.

Why the {211}<011> oriented grains secondary recrystallize in the end portion of the longitudinal direction of the coil is not clear, but is presumed as follows.

The end portion in the longitudinal direction of the coil may be heated more than desired during hot rolling, and the surface layer of the steel sheet in such an excessively heated part is easily decarburized during hot rolling. When the surface layer of the steel sheet is decarburized, the austenite ratio during hot rolling decreases. As a result, the {211}<011> orientation, which is a stable rolling orientation of ferrite, is easily developed in the surface layer of the steel sheet. It is presumed that the {211}<011> orientation is inherited and further developed even after cold rolling, and as a result, many secondary recrystallized grains having the {211}<011> orientation (hereinafter, also referred to as “{211}<011> secondary recrystallized grains”) are formed. Presumably, particularly when a grain-oriented electrical steel sheet is manufactured in a high cold rolling ratio, the {211}<011> orientation developed during hot rolling is easily inherited during cold rolling.

As described above, the {211}<011> secondary recrystallized grains cause the deterioration of the magnetic characteristics. Therefore, the present inventors have extensively studied means for suppressing the formation of {211}<011> secondary recrystallized grains.

First, the present inventors investigated what facilitates the secondary recrystallization of {211}<011> oriented grains, and presumed that this is partially because the Goss orientation ({110}<001> orientation), which serves as a nucleus of the secondary recrystallization, decreases. It is considered that the reduction of the Goss orientation facilitates the secondary recrystallization of {211}<011> oriented grains particularly when the grain-oriented electrical steel sheet is manufactured at a high cold rolling reduction.

Therefore, a method for enriching the Goss orientation was examined.

As a method for enriching the Goss orientation, a technique of rapidly heating during the temperature rising process of the decarburization annealing step has been conventionally known. However, for grain-oriented electrical steel sheets, {211}<011> oriented grains having inferior magnetic characteristics may be secondary recrystallized, so that good magnetic characteristics are not obtained or the magnetic characteristics vary.

From such a background, the present inventors have further advanced the treatment technique of rapid heating in the temperature rising process of the decarburization annealing step. As a result, the present inventors have found that it is effective for suppressing the secondary recrystallization of {211}<011> oriented grains to perform the combination of: precise control of the irradiation conditions of local rapid heating treatment with a laser beam; and control of the oxygen potential in the decarburization annealing step in accordance with the laser beam irradiation conditions.

In the conventional heating method such as radiation heating, energization heating, and induction heating, the temperature rising rate is increased in the temperature rising process of the annealing step, thereby enriching Goss oriented grains, which serves as a nucleus of secondary recrystallization. On the other hand, in such a conventional heating method, the number of oriented grains near the {111}<112>, which promotes the growth of Goss oriented grains, tends to decrease in the steel sheet at the central part in the sheet thickness direction. Therefore, there is limitation in improving the magnetic characteristics by increasing the temperature rising rate in the annealing step. In particular, a grain-oriented electrical steel sheet having a thin sheet thickness has a problem in decreasing the number of Goss oriented grains, which serve as a nucleus of secondary recrystallization. However, when a conventional heating method is applied, the entire sheet thickness is heated, and a sufficient effect cannot be obtained for the above-described reason.

On the other hand, in local rapid heating treatment with a laser beam, only the surface layer of the steel sheet (in particular, ⅕ thickness) is rapidly heated. Accordingly, the Goss oriented grains, which serve as a nucleus of secondary recrystallization, can be enriched at the surface layer of the steel sheet, and the reduction of the number of oriented grains near the {111}<112> can be suppressed in the central part of the sheet thickness of the steel sheet. Therefore, it is possible to promote the secondary recrystallization of Goss oriented grains, which are superior in magnetic properties.

However, the present inventors investigated the relationship between the laser beam irradiation conditions and each characteristic of the electrical steel sheet, and found that coating adhesion may deteriorate. After specific examination, it has been found that the annealing conditions (in particular, heat equalization conditions) in the decarburization annealing step affect the coating adhesion, and it has been found that it is effective for improving coating adhesion to control the laser beam irradiation conditions and the annealing conditions within an appropriate range.

It has been found that the decrease in coating adhesion is due to the decrease in the forsterite (Mg₂SiO₄) coating as a primary coating in the laser beam irradiation part. Why the primary coating is decreased in the laser beam irradiation part is not clear. However, it is presumed that, in the laser beam irradiation part, the SiO₂ internal oxide layer is difficult to form in the decarburization annealing step, and the amount of the primary coating formed is locally decreased in the final annealing step, which is a subsequent step.

Therefore, the present inventors have intensively studied the annealing conditions in the decarburization annealing step in order to promote the formation of the SiO₂ internal oxide layer in the laser beam irradiation part. As a result, the present inventors have found that it is effective for promoting the formation of the SiO₂ internal oxide layer to suppress the oxygen potential in the heat equalizing process in the decarburization annealing step in accordance with the laser beam irradiation conditions. Presumably, although the oxygen adhesion amount is reduced in the entire steel sheet when the oxygen potential is reduced in the heat equalizing process, the formation of the SiO₂ internal oxide layer is promoted, instead of an iron-based oxide layer, in the laser beam irradiation part.

Hereinafter, a grain-oriented electrical steel sheet according to an embodiment of the present invention made based on the above findings and a manufacturing method of the same will be described in detail.

### <2. Manufacturing Method of Grain-Oriented Electrical Steel Sheet>

Hereinafter, a manufacturing method of a grain-oriented electrical steel sheet according to an embodiment of the present disclosure (manufacturing method of a grain-oriented electrical steel sheet according to the embodiment) will be described.

The manufacturing method of a grain-oriented electrical steel sheet according to the embodiment includes the following steps:
(I) a hot rolling step of heating a slab having a predetermined chemical composition and hot rolling the heated slab to obtain a hot-rolled steel sheet;
(II) a hot-band annealing step of annealing the hot-rolled steel sheet;
(III) a cold rolling step of cold rolling the hot-rolled steel sheet after the hot-band annealing step to obtain a cold-rolled steel sheet;
(IV) a decarburization annealing step of decarburization annealing the cold-rolled steel sheet to obtain a decarburization-annealed steel sheet; and
(V) a final annealing step of final annealing the decarburization-annealed steel sheet.

Each step will be described below. For steps or conditions that are not described, known steps and conditions can be applied.

### (Hot Rolling Step)

In the hot rolling step, a slab having a chemical composition described below is heated to 1280° C. or higher, and the heated slab is hot-rolled to obtain a hot-rolled steel sheet.

When the heating temperature is lower than 1280° C., the inclusion formed in the slab cannot be dissolved, and inhibitors are not sufficiently formed in the hot rolling step or the hot-band annealing step described later. Thus, the heating temperature of the slab is 1280° C. or higher. The upper limit of the slab heating temperature is not limited, but when heated at higher than 1450° C., the slab or the like melts and becomes difficult in hot rolling. Thus, the slab heating temperature is preferably 1450° C. or lower.

The hot rolling conditions are not particularly limited, and may be appropriately set based on required characteristics. The sheet thickness of the hot-rolled steel sheet obtained by hot rolling is preferably, for example, in a range of 1.0 mm or more and 4.0 mm or less.

### [Chemical Composition of Slab]

In order to obtain preferable magnetic characteristics as a grain-oriented electrical steel sheet, the chemical composition of the slab subjected to hot rolling is in the following range. In the following description, unless otherwise specified, the notation “%” represents “mass %”. In a range of numerical value limitation described below with “to” interposed therebetween, the lower limit and the upper limit are included in the range. A numerical value indicated as “less than” or “more than” is not included in the numerical range.

### C: 0.010 to 0.100%

Carbon (C) is an element exhibiting an effect of improving the magnetic flux density, but when the C content of the slab exceeds 0.100%, productivity in the decarburization annealing step decreases. In addition, when the C content of the slab is large and decarburization is insufficient, steel undergoes phase transformation in secondary recrystallization annealing (that is, final annealing), and secondary recrystallization does not sufficiently proceed, as a result of which a favorable magnetic flux density and a low iron loss cannot be obtained, or magnetic characteristics are deteriorated due to magnetic aging. Thus, the C content of the slab is 0.100% or less. The lower the C content, the better for productivity and iron loss reduction. From the viewpoint of productivity and iron loss reduction, the C content is preferably 0.090% or less, and more preferably 0.080% or less.

On the other hand, when the C content of the slab is less than 0.010%, the effect of improving the magnetic flux density cannot be obtained. Thus, the C content of the slab is 0.010% or more. The C content is preferably 0.040% or more, and more preferably 0.060% or more.

### Si: 2.50 to 4.00%

Si (silicon) is an extremely effective element for increasing electric resistance (specific resistance) of steel to reduce eddy-current loss constituting a part of iron loss. When the Si content of the slab is less than 2.50%, the inherent resistance is small, and the eddy-current loss cannot be sufficiently reduced. In addition, since the steel undergoes phase transformation in the secondary recrystallization annealing, the secondary recrystallization does not sufficiently proceed, and a favorable magnetic flux density and a low iron loss cannot be obtained. Thus, the Si content of the slab is 2.50% or more. The Si content of the slab is preferably 2.70% or more, more preferably 2.80% or more.

On the other hand, when the Si content exceeds 4.00%, the steel sheet is embrittled, and the passability of the sheet in the manufacturing step is remarkably deteriorated. Thus, the Si content of the slab is 4.00% or less. The Si content of the slab is preferably 3.90% or less, more preferably 3.80% or less.

### Mn: 0.01 to 0.30%

Mn (manganese) is an important element that forms MnS, which is one of the major inhibitors. When the Mn content of the slab is less than 0.01%, the absolute amount of MnS required to cause secondary recrystallization is insufficient. Thus, the Mn content of the slab is 0.01% or more. The Mn content is preferably 0.03% or more, and more preferably 0.06% or more.

On the other hand, when the Mn content of the slab exceeds 0.30%, the steel undergoes phase transformation in the secondary recrystallization annealing, secondary recrystallization does not sufficiently proceed, and a favorable magnetic flux density and a low iron loss cannot be obtained.

Thus, the Mn content of the slab is 0.30% or less. The Mn content is preferably 0.28% or less, and more preferably 0.26% or less.

At least one selected from the group consisting of group consisting of S and Se: 0.010 to 0.050%

S (sulfur) and Se (selenium) are elements that react with Mn to form inhibitors MnS and MnSe. Since MnS or MnSe is required to form as the inhibitor, one of S and Se may be contained in the slab, or the two may be contained in the slab. When the total of one or two of S and Se is less than 0.010%, a sufficient inhibitor is not formed. Thus, the total of one or two of S and Se is 0.010% or more. The total of one or two of S and Se is preferably 0.020% or more. On the other hand, when the total of one or two of S and Se exceeds 0.050%, hot embrittlement is caused, and hot rolling is significantly difficult. Thus, the total of one or two of S and Se is 0.050% or less. The total of one or two of S and Se is preferably 0.040% or less, and more preferably 0.030% or less.

Sol. Al: 0.010 to 0.050%

Sol. Al (acid-soluble aluminum) is a constituent element of a main inhibitor among compounds called inhibitors that influence secondary recrystallization in the grain-oriented electrical steel sheet, and is an essential element from the viewpoint of development of secondary recrystallization in the base steel sheet according to the embodiment. When the sol. Al content of the slab is less than 0.010%, AlN functioning as an inhibitor is not sufficiently generated, and secondary recrystallization becomes insufficient. Thus, the content of sol. Al is 0.010% or more. The amount of sol. Al is preferably 0.020% or more. On the other hand, when the amount of sol. Al exceeds 0.050%, AlN functioning as an inhibitor is not sufficiently generated, and secondary recrystallization becomes insufficient. Thus, the amount of sol. Al is 0.050% or less. The amount of sol. Al is preferably 0.040% or less, and more preferably 0.030% or less.

### N: 0.0030 to 0.0150%

N (nitrogen) is an element that reacts with the acid-soluble Al to form AlN that functions as an inhibitor. In order to sufficiently form AlN functioning as an inhibitor, the N content is 0.0030% or more. The N content is preferably 0.0050% or more.

On the other hand, when the N content is more than 0.0150%, blisters (pores) are generated in the steel sheet during cold rolling, the strength of the steel sheet increases, and the passability of the sheet during manufacture deteriorates. Thus, the N content of the slab is 0.0150% or less. The N content is preferably 0.0130% or less and more preferably 0.0100% or less.

### Ni: 0 to 0.50%

Ni (nickel) is an element effective for increasing electric resistance and reducing iron loss. Ni is an element effective for controlling the metallographic structure of the hot-rolled steel sheet to enhance the magnetic characteristics. Thus, Ni may be contained. When such an effect is obtained, the Ni content is preferably 0.01% or more. The Ni content is more preferably 0.02% or more.

On the other hand, when the Ni content is more than 0.50%, secondary recrystallization may become unstable. Thus, the Ni content is 0.50% or less. The Ni content is preferably 0.30% or less.

### Cu: 0 to 0.50%

Cu (copper) is an element that contributes to an increase in the occupancy rate of the Goss orientation in the secondary recrystallization structure and contributes to an improvement in the glass coating adhesion. Thus, Cu may be contained. When such an effect is obtained, the Cu content is preferably 0.01% or more. The Cu content is more preferably 0.02% or more, and still more preferably 0.03% or more.

On the other hand, when the Cu content exceeds 0.50%, the steel sheet is embrittled during hot rolling. Thus, the Cu content of the slab is 0.50% or less. The Cu content is preferably 0.30% or less, more preferably 0.10% or less.

### Sb: 0 to 0.30%

Sb (antimony) is an element having an effect of improving magnetic characteristics. Thus, Sb may be contained. When Sb is contained, the content is preferably 0.01% or more so that Sb favorably exhibits the effect of improving magnetic characteristics. The Sb content is more preferably 0.02% or more.

On the other hand, when the Sb content exceeds 0.30%, the adhesion of the glass coating is deteriorated. Thus, the Sb content is 0.30% or less. The Sb content is preferably 0.20% or less.

### Sn: 0 to 0.30%

Sn (tin) is an element having an effect of improving magnetic characteristics. Thus, Sn may be contained. When Sn is contained, the Sn content is preferably 0.01% or more in order to favorably exhibit the effect of improving magnetic characteristics. The Sn content is preferably 0.02% or more, and more preferably 0.03% or more in consideration of both magnetic characteristics and coating adhesion.

On the other hand, when the Sn content exceeds 0.30%, the glass coating is remarkably deteriorated, and tension sufficient for magnetic domain refinement cannot be obtained, as a result of which iron loss characteristics are deteriorated. Thus, the Sn content is 0.30% or less. The Sn content is preferably 0.20% or less and more preferably 0.15% or less.

### Cr: 0 to 0.50%

Cr (chromium), similarly to Sn and Cu described later, is an element that contributes to an increase in the occupancy rate of the Goss orientation in the secondary recrystallization structure to improve the magnetic characteristics, and contributes to an improvement in the adhesion of the glass coating. Thus, Cr may be contained. In order to obtain the above effect, the Cr content is preferably 0.01% or more, more preferably 0.02% or more, and still more preferably 0.03% or more.

On the other hand, when the Cr content exceeds 0.50%, Cr oxide is formed, and the magnetic characteristics are deteriorated. Thus, the Cr content is 0.50% or less. The Cr content is preferably 0.30% or less, more preferably 0.10% or less.

### P: 0 to 0.05%

P (phosphorus) is an element that lowers the workability in rolling. When the P content is 0.05% or less, it is possible to suppress excessive reduction in rolling workability and to suppress fracture during manufacturing. From such a viewpoint, the P content is 0.05% or less. The P content is preferably 0.04% or less.

The lower limit of the P content is not limited, and may include 0%, but P is also an element having an effect of improving the texture and improving the magnetic characteristics. In order to obtain this effect, the P content may be 0.005% or more, or may be 0.01% or more.

### Mo: 0 to 0.05%

Mo (molybdenum) is an element having an effect of improving magnetic characteristics. Thus, Mo may be contained. When Mo is contained, the Mo content is preferably 0.01% or more in order to favorably exhibit the effect of improving magnetic characteristics. The Mo content is more preferably 0.02% or more, and still more preferably 0.03% or more.

On the other hand, when the Mo content is more than 0.05%, the cold rolling characteristics may be deteriorated, leading to fracture. Therefore, the Mo content is 0.05% or less. The Mo content is preferably 0.04% or less.

### Ta: 0 to 0.05%

Ta (tantalum) is a useful element that bonds with N or C to function as an inhibitor. When such an effect is obtained, the Ta content may be more than 0.0000%, or may be 0.0005% or more. On the other hand, when the Ta content is more than 0.05%, the magnetic characteristics may be deteriorated. Therefore, the Ta content may be 0.05% or less. The Ta content is preferably 0.04% or less.

### Nb: 0 to 0.010%

Nb (niobium) has an action of stabilizing secondary recrystallization. When such an effect is obtained, the Nb content may be more than 0.0000%, or may be 0.0005% or more. On the other hand, when the Nb content is more than 0.010%, secondary recrystallization may become unstable. Therefore, the Nb content may be 0.010% or less. The Nb content is preferably 0.0050% or less.

### V: 0 to 0.50%

V (vanadium) is an effective element that bonds with N or C to function as an inhibitor. Thus, V may be contained. When such an effect is obtained, the V content is preferably 0.01% or more, and more preferably 0.02% or more.

On the other hand, when the V content exceeds 0.50%, the magnetic characteristics may be deteriorated. Therefore, the V content is 0.50% or less. The V content is preferably 0.30% or less, and more preferably 0.20% or less.

### B: 0 to 0.0200%

B (boron) has an action of stabilizing secondary recrystallization. When such an effect is obtained, the B content may be more than 0.0000%, or may be 0.0005% or more. On the other hand, when the B content is more than 0.0200%, secondary recrystallization may become unstable. Therefore, the B content may be 0.0200% or less. The B content is preferably 0.0100% or less, and more preferably 0.0050% or less.

### Bi: 0 to 0.0200%

Bi (bismuth) has an effect of improving the magnetic characteristics. Therefore, Bi may be contained. When such an effect is obtained, the Bi content may be more than 0.0000%, or may be 0.0005% or more. On the other hand, when the Bi content is more than 0.0200%, the passability of the sheet during cold rolling may be deteriorated. In addition, when the purification during the final annealing is insufficient and Bi remains excessively, the magnetic characteristics may be adversely affected. Therefore, the Bi content may be 0.0200% or less. The Bi content is preferably 0.0150% or less, and more preferably 0.0100% or less.

### Te: 0 to 0.0200%

Te (tellurium) has an action of stabilizing secondary recrystallization. When such an effect is obtained, the Te content may be more than 0.0000%, or may be 0.0005% or more. When the Te content is more than 0.0200%, fracture may occur during hot rolling or cold rolling. Therefore, the Te content may be 0.0200% or less. The Te content is preferably 0.0150% or less, and more preferably 0.0100% or less.

### Balance: Fe and Impurities

The chemical composition of the slab used in the manufacturing method of a grain-oriented electrical steel sheet according to the embodiment may contain the above-described elements, and the balance may be Fe and impurities. Here, the impurities are contaminated from ore or scrap as a raw material, or from a manufacturing environment or the like when the base steel sheet is industrially manufactured. The impurities mean elements allowed to be included in such a content that the action of the grain-oriented electrical steel sheet according to the embodiment is not adversely affected.

### (Hot-Band Annealing Step)

The hot-band annealing step is a step of annealing the hot-rolled steel sheet manufactured through the hot rolling step. By performing such an annealing treatment, recrystallization occurs in the metallographic structure of the steel sheet, and favorable magnetic characteristics can be realized.

In the hot-band annealing step of the embodiment, the hot-rolled steel sheet manufactured through the hot rolling step may be annealed according to a known method. The method for heating the hot-rolled steel sheet at the time of annealing is not particularly limited, and a known heating method can be adopted. The annealing conditions are also not particularly limited, but for example, the hot-rolled steel sheet can be annealed in a temperature range of 900 to 1200° C. for 10 seconds to 5 minutes.

### (Cold Rolling Step)

In the cold rolling step, the hot-rolled steel sheet after the hot-band annealing step is subjected to cold rolling including a plurality of passes to obtain a cold-rolled steel sheet. The cold rolling may be performed one time. Alternatively, before the final pass in the cold rolling step, intermediate annealing may be performed at least one time or two or more times by interrupting cold rolling, that is, cold rolling may be performed several times with intervening intermediate annealing(s).

When the intermediate annealing is performed, the temperature is preferably held at 1000 to 1200° C. for 5 to 180 seconds. The annealing atmosphere is not particularly limited. The number of times of intermediate annealing is preferably 3 or less in consideration of manufacturing cost.

The total rolling reduction is 89% or more in the cold rolling step. When the total rolling reduction is less than 89%, a suitable primary recrystallization texture cannot be obtained. Specifically, when the total rolling reduction is less than 89%, the sharpness of the Goss orientation, which serves as a nucleus of secondary recrystallization, cannot be sufficiently obtained, and thus good magnetic characteristics may fail to be obtained. In the cold rolling step, the total rolling reduction is preferably 90% or more, more preferably 91% or more, and still more preferably 92% or more.

Before the cold rolling step, the surface of the hot-rolled steel sheet may be subjected to pickling under known conditions.

### (Decarburization Annealing Step)

In the decarburization annealing step, the cold-rolled steel sheet is decarburization annealed to obtain a decarburization-annealed steel sheet. In the decarburization annealing, the cold-rolled steel sheet is primarily recrystallized, and C, which adversely affects the magnetic characteristics, is removed from the steel sheet. In the manufacturing method of a grain-oriented electrical steel sheet according to the embodiment, the steel sheet is locally heated before heated to an annealing temperature.

That is, the decarburization annealing step according to the embodiment includes:
(IV-1) a local heating process of partly heating the surface of the cold-rolled steel sheet by irradiating with a laser beam in an air atmosphere at an interval of 5 to 30 mm in a direction that forms 30 to 150° with respect to the rolling direction;
(IV-2) a temperature rising process of raising the temperature of the cold-rolled steel sheet after the local heating process in a non-oxidizing atmosphere from a temperature range of 450° C. or lower to a temperature range of 750 to 950° C., which is a temperature for decarburization annealing, at an average heating rate of 80° C./sec or more; and
(IV-3) a heat equalizing process of decarburization annealing the cold-rolled steel sheet after the temperature rising process at an oxygen potential P_{O} satisfying the following equation (1).

### [Local Heating Process]

In the local heating process, the surface of the cold-rolled steel sheet is partly heated by irradiating with a laser beam in an air atmosphere at an interval of 5 to 30 mm in a direction that forms 30 to 150° with respect to the rolling direction.

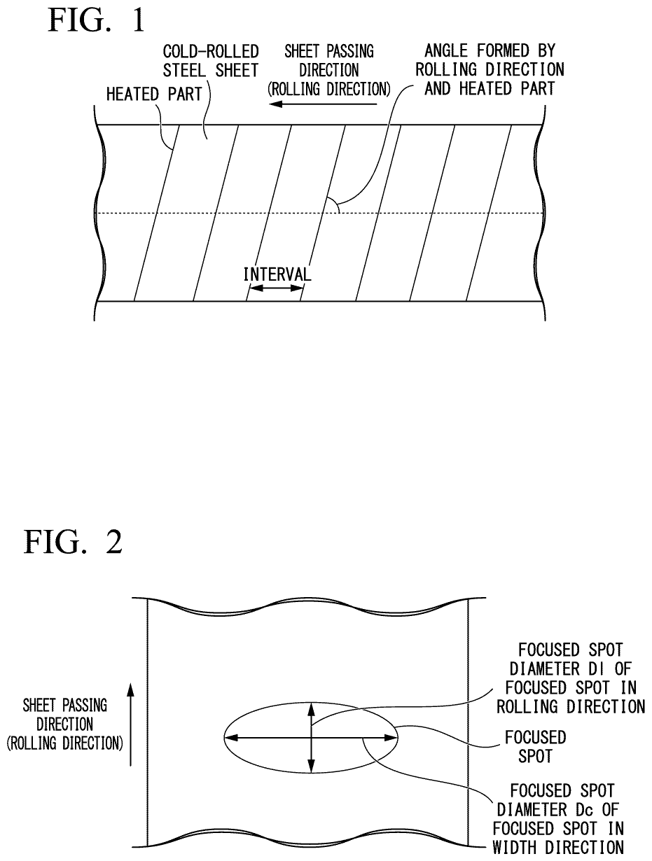

More specifically, in the local heating process, the surface of the cold-rolled steel sheet is heated in an air atmosphere so that the heated part made with a laser beam extends in a direction that forms 30 to 150° with respect to the rolling direction (in a ±60° direction with respect to the direction perpendicular to the rolling direction), and becomes a plurality of lines positioned at an interval of 5 to 30 mm in the rolling direction. The cold-rolled steel sheet after the local heating has linear heated parts as shown in FIG. 1.

In the manufacturing method of a grain-oriented electrical steel sheet according to the embodiment, the steel sheet is locally heated so that Goss oriented grains are enriched in the heated parts. The arrangement of the regions enriched with Goss oriented grains may be lines extending in a direction intersecting the above-described rolling direction, and the lines are preferably repeated at a predetermined interval in the rolling direction.

The extending direction of the linear heated part is less than 30° or more than 150° with respect to the rolling direction.

When the extending direction is nearly parallel to the rolling direction (30° or more, or 150° or less), the secondarily recrystallized Goss oriented grains have a large deviation angle, thereby sometimes decreasing the magnetic flux density, though the cause is unknown.

When the linear heated part has an interval of larger than 30 mm, Goss oriented grains, which serve as a nucleus of secondary recrystallization, cannot be sufficiently obtained, thereby sometimes decreasing the magnetic flux density. On the other hand, when the linear heated part has an interval of less than 5 mm, the number of Goss oriented grains is excessive, and the number of grains with coincidence site lattice orientation that promote the growth of Goss oriented grains is reduced, thereby decreasing the development degree to the Goss orientation.

The interval between the linear heated parts may be substantially equal to each other, but may be controlled such that each of the adjacent linear heated parts has different intervals as long as it is within the range of the interval of the linear heated part described above. For example, when a coil-shaped steel sheet is annealed in the final annealing step, the curvature is small in the inner peripheral portion thereof, in which the interval of the heated parts may be narrowed so that Goss oriented grains, which serve as a nucleus of secondary recrystallization, are enriched and secondary recrystallized grains become smaller.

The width of the linear heated part is preferably 0.2 to 1.0 mm. When the width is less than 0.2 mm, the heated part is small, and the enriching effect of Goss oriented grains is reduced. On the other hand, when the width is more than 1.0 mm, the enriching effect of Goss oriented grains is obtained, but the number of grains with coincidence site lattice orientation is reduced, and the deviation angle from the Goss orientation increases after secondary recrystallization.

The length of the linear heated part is not limited, but the linear heated part is preferably formed across the entire region in the width direction of the steel sheet, or across the entire region in the width direction excluding the edge portion.

In addition, for local heating (formation of linear heated part), a laser beam is irradiated for heating because local heating can be achieved and the influence on the surroundings is small.

When heating is performed by laser beam irradiation, the laser beam is irradiated under conditions satisfying the following equation (2), where the average intensity of the laser beam is defined as P (W), the focused spot diameter of the focused spot in the rolling direction is defined as Dl (mm), the focused spot diameter of the focused spot in the width direction is defined as Dc (mm), the irradiation time is defined as t (sec), and the instantaneous input energy represented by 4/π×P/(Dl×Dc)×t is defined as Up (J/mm²).

The focused spot diameter Dl is the diameter of the focused spot illustrated in FIG. 2 in the rolling direction. The focused spot diameter Dc is the diameter of the focused spot illustrated in FIG. 2 in the width direction (in the direction orthogonal to the rolling direction). The passing steel sheet is irradiated with a laser beam for a predetermined time t. When the irradiation is performed on the entire steel sheet in the width direction, a plurality of irradiation spots may be arranged in series in the width direction.

$$0.5 \leq Up \leq 5 \qquad ( 2 )$$

When the conditions satisfy the equation (2), the length of the secondary recrystallized grains in the rolling direction can be reduced, and the difference in development degree to the Goss orientation is reduced. When the equation (2) is not satisfied, a sufficient effect cannot be obtained.

In the embodiment, the purpose of irradiating a laser beam is not magnetic domain control but microstructure control as described above. That is, in the temperature rising process of the decarburization annealing step in the embodiment, only the surface layer of the steel sheet is locally heated, and grooves are not formed at the surface of the steel sheet as in the general magnetic domain control.

### [Temperature Rising Process]

In the temperature rising process, the cold-rolled steel sheet after the local heating process is heated in a non-oxidizing atmosphere from a temperature range of 450° C. or lower to a temperature range of 750 to 950° C., which is a temperature for decarburization annealing, at an average heating rate of 80° C./sec or more.

The above temperature increase promotes the generation of nuclei of GOSS oriented grains. When the average heating rate in the temperature range is less than 80° C./sec, nuclei are insufficiently generated, and the grain size of secondary recrystallized grains increases. In addition, when local heating is performed to reduce the secondary recrystallization grain size in the rolling direction, sufficient nuclei of secondary recrystallization are required in order to completely cover the entire surface of the steel sheet with the GOSS orientation, which is favorable for magnetic characteristics. Therefore, the average heating rate is preferably 160° C./sec or more, and more preferably 240° C./sec or more. The upper limit of the temperature rising rate is not limited, and may be determined by facility capacity. For example, the temperature rising rate is 2000° C./sec or less.

When the atmosphere during temperature rise is not a non-oxidizing atmosphere, a tight SiO₂ coating is formed on the surface layer of the steel sheet, and a decarburization defect or a coating defect after final annealing occurs. In the embodiment, the non-oxidizing atmosphere is a nitrogen atmosphere or a nitrogen/hydrogen mixed atmosphere, and is an atmosphere having a dew point of −50° C. or higher and 0° C. or lower. The dew point is preferably −5° C. or lower, or −10° C. or lower, from the viewpoint of suppressing the generation of SiO₂ in the surface layer of the steel sheet and favorably advancing decarburization. The dew point may be, for example, −40° C. or higher from the viewpoint of favorably promoting internal oxidation, which is easily process-controlled.

The annealing after raising the temperature to 750 to 950° C. in the temperature rising process is not limited. For example, the oxidation degree (PH₂O/PH₂) in the annealing atmosphere (in-furnace atmosphere) is 0.15 to 1.0, and the temperature range is held for 10 to 600 seconds.

### [Heat Equalizing Process]

In the heat equalizing process, the cold-rolled steel sheet after the temperature rising process is decarburization annealed at an oxygen potential P_{O} satisfying the following equation (1).

$${P}_{O} \leq 0.6 - 0.04 Up \qquad ( 1 )$$

As described above, it is considered that the SiO₂ internal oxide layer is more difficult to form in the heat equalizing process in the laser beam irradiation part than in the non-irradiation part, and therefore, the amount of the formed primary coating is decreased in the laser beam irradiation part in the final annealing step, which is a subsequent step, resulting in reduced coating adhesion.

Therefore, in the heat equalizing process in the embodiment, the oxygen potential P_{O} is maintained at a low level in the heat equalizing process, in accordance with the laser beam irradiation conditions, specifically, “Up”, to promote the formation of the SiO₂ internal oxide layer in the heat equalizing process. Specifically, annealing is performed with an oxygen potential P_{O} satisfying the equation (1).

Through the decarburization annealing step as described above, Goss oriented grains, which serve as a nuclei of secondary recrystallization, are enriched only at the surface layer of the steel sheet by local rapid heating with a laser beam; the secondary recrystallization of Goss oriented grains, which are superior in magnetic characteristics, can be promoted; and the formation of the SiO₂ internal oxide layer can be promoted in the entire steel sheet including the laser beam irradiation part. Thereby, both excellent magnetic characteristics and excellent coating adhesion can be achieved.

### (Final Annealing Step)

In the final annealing step, a predetermined annealing separator is applied to one surface or both surfaces of the decarburization-annealed steel sheet obtained in the decarburization annealing step, and then final annealing is performed. The final annealing is generally performed for a long time in a state where the steel sheet is wound in a coil shape. Thus, prior to the final annealing, an annealing separator is applied to the decarburization-annealed steel sheet and dried for the purpose of preventing seizure between the inside and the outside of the winding of the coil.

As the annealing separator to be applied, an annealing separator containing MgO as a main component (for example, containing 80% or more in terms of weight fraction) is used. By using an annealing separator containing MgO as a main component, a glass coating can be formed on the surface of the base steel sheet. When MgO is not a main component, no primary coating (glass coating) is formed. This is because the primary coating is made of an Mg₂SiO₄ or MgAl₂O₄ compound, and Mg necessary for the formation reaction is insufficient when MgO is not a main component.

The final annealing may be performed, for example, under conditions in which the temperature is raised to 1150 to 1250° C. in an atmosphere gas containing hydrogen and nitrogen, and annealing is performed in the temperature range for 10 to 60 hours.

### <3. Grain-Oriented Electrical Steel Sheet>

Next, the grain-oriented electrical steel sheet obtained by the above manufacturing method will be described.

### (3-1. Chemical Composition of Base Steel Sheet)

First, the chemical composition of the base steel sheet of the grain-oriented electrical steel sheet will be described. In the following description, unless otherwise specified, the notation “%” represents “mass %” with respect to the total mass of the base steel sheet.

### C: 0.0005 to 0.010%

Since C (carbon) is an element that adversely affects the magnetic characteristics of the grain-oriented electrical steel sheet, the C content is preferably as low as possible. In the embodiment, the C content is 0.010% or less. It is industrially difficult that the C content becomes completely 0%. Therefore, the lower limit of the C content is substantially about 0.0005%.

### Si: 2.50 to 4.00%

Si (silicon) is an extremely effective element for increasing the electric resistance (specific resistance) of steel to reduce eddy-current loss constituting a part of iron loss. When the Si content is less than 2.50%, the inherent resistance is small, and the eddy-current loss cannot be sufficiently reduced. In addition, since the steel undergoes phase transformation in the secondary recrystallization annealing, the secondary recrystallization does not sufficiently proceed, and a favorable magnetic flux density and a low iron loss cannot be obtained.

Therefore, the Si content is 2.50% or more. The Si content is preferably 2.70% or more, and more preferably 2.80% or more.

On the other hand, when the Si content exceeds 4.00%, the steel sheet is embrittled, and the passability of the sheet in the manufacturing step is remarkably deteriorated. Therefore, the Si content is 4.00% or less. The Si content is preferably 3.90% or less, and more preferably 3.80% or less.

### Mn: 0.01 to 0.30%

Mn (manganese) is an important element that forms MnS, which is one of the major inhibitors. When the Mn content is less than 0.01%, the absolute amount of MnS required to cause secondary recrystallization is insufficient. Therefore, the Mn content is 0.01% or more. The Mn content is preferably 0.03% or more, and more preferably 0.06% or more.

On the other hand, when the Mn content exceeds 0.30%, the steel undergoes phase transformation in the secondary recrystallization annealing, secondary recrystallization does not sufficiently proceed, and a favorable magnetic flux density and a low iron loss cannot be obtained. Therefore, the Mn content is 0.30% or less. The Mn content is preferably 0.28% or less, and more preferably 0.26% or less.

At least one selected from the group consisting of group consisting of S and Se: 0 to 0.010%

S and Se are raw materials of MnS and MnSe as an inhibitor, but the content thereof in the base steel sheet is preferably as low as possible because S and Se are elements that adversely affect the magnetic characteristics of the grain-oriented electrical steel sheet. In the embodiment, the total amount of S and Se is 0.010% or less. The total amount of S and Se may be 0%. The total amount of S and Se may be 0.0005% or more.

Sol. Al: 0 to 0.010%

As described above, sol. Al is a raw material of AlN as an inhibitor, but the content thereof in the base steel sheet is preferably as low as possible because sol. Al is an element that adversely affects the magnetic characteristics of the grain-oriented electrical steel sheet. In the embodiment, the amount of sol. Al is 0.010% or less. The amount of sol. Al may be 0%. The amount of sol. Al may be 0.0005% or more.

### N: 0.0001 to 0.0100%

As described above, N is a raw material of AlN as an inhibitor, but the content thereof in the base steel sheet is preferably as low as possible because N is an element that adversely affects the magnetic characteristics of the grain-oriented electrical steel sheet. In the embodiment, the N content is 0.0100% or less. It is industrially difficult that the N content becomes completely 0%. Therefore, the lower limit of the N content is substantially about 0.0001%.

### Ni: 0 to 0.50%

Ni (nickel) is an element effective for increasing electric resistance and reducing iron loss. Ni is an element effective for controlling the metallographic structure of the hot-rolled steel sheet to enhance the magnetic characteristics. Thus, Ni may be contained. When such an effect is obtained, the Ni content is preferably 0.01% or more. The Ni content is more preferably 0.02% or more.

On the other hand, when the Ni content is more than 0.50%, secondary recrystallization may become unstable. Thus, the Ni content is 0.50% or less. The Ni content is preferably 0.30% or less.

### Cu: 0 to 0.50%

Cu (copper) is an element that contributes to an increase in the occupancy rate of the Goss orientation in the secondary recrystallization structure and contributes to an improvement in the glass coating adhesion. Thus, Cu may be contained. When such an effect is obtained, the Cu content is preferably 0.01% or more. The Cu content is more preferably 0.02% or more, and still more preferably 0.03% or more.

On the other hand, when the Cu content exceeds 0.50%, the steel sheet is embrittled during hot rolling. Thus, the Cu content of the slab is 0.50% or less. The Cu content is preferably 0.30% or less, more preferably 0.10% or less.

### Sb: 0 to 0.30%

Sb (antimony) is an element having an effect of improving magnetic characteristics. Thus, Sb may be contained. When Sb is contained, the content is preferably 0.01% or more so that Sb favorably exhibits the effect of improving magnetic characteristics. The Sb content is more preferably 0.02% or more.

On the other hand, when the Sb content exceeds 0.30%, the adhesion of the glass coating is deteriorated. Thus, the Sb content is 0.30% or less. The Sb content is preferably 0.20% or less.

### Sn: 0 to 0.30%

Sn (tin) is an element having an effect of improving magnetic characteristics. Thus, Sn may be contained. When Sn is contained, the Sn content is preferably 0.01% or more in order to favorably exhibit the effect of improving magnetic characteristics. The Sn content is preferably 0.02% or more, and more preferably 0.03% or more in consideration of both magnetic characteristics and coating adhesion.

On the other hand, when the Sn content exceeds 0.30%, the glass coating is remarkably deteriorated, and tension sufficient for magnetic domain refinement cannot be obtained, as a result of which iron loss characteristics are deteriorated. Thus, the Sn content is 0.30% or less. The Sn content is preferably 0.20% or less and more preferably 0.15% or less.

### Cr: 0 to 0.50%

Cr (chromium), similarly to Sn and Cu described later, is an element that contributes to an increase in the occupancy rate of the Goss orientation in the secondary recrystallization structure to improve the magnetic characteristics, and contributes to an improvement in the adhesion of the glass coating. Thus, Cr may be contained. In order to obtain the above effect, the Cr content is preferably 0.01% or more, more preferably 0.02% or more, and still more preferably 0.03% or more.

On the other hand, when the Cr content exceeds 0.50%, Cr oxide is formed, and the magnetic characteristics are deteriorated. Thus, the Cr content is 0.50% or less. The Cr content is preferably 0.30% or less, more preferably 0.10% or less.

### P: 0 to 0.05%

P (phosphorus) is an element that lowers the workability in rolling. When the P content is 0.05% or less, it is possible to suppress excessive reduction in rolling workability and to suppress fracture during manufacturing. From such a viewpoint, the P content is 0.05% or less. The P content is preferably 0.04% or less.

The lower limit of the P content is not limited, and may include 0%, but P is also an element having an effect of improving the texture and improving the magnetic characteristics. In order to obtain this effect, the P content may be 0.005% or more, or may be 0.01% or more.

### Mo: 0 to 0.05%

Mo (molybdenum) is an element having an effect of improving magnetic characteristics. Thus, Mo may be contained. When Mo is contained, the Mo content is preferably 0.01% or more in order to favorably exhibit the effect of improving magnetic characteristics. The Mo content is more preferably 0.02% or more, and still more preferably 0.03% or more.

On the other hand, when the Mo content is more than 0.05%, the cold rolling characteristics may be deteriorated, leading to fracture. Therefore, the Mo content is 0.05% or less. The Mo content is preferably 0.04% or less.

### Ta: 0 to 0.05%

Ta (tantalum) has an action of stabilizing secondary recrystallization. When such an effect is obtained, the Ta content may be more than 0.0000%, or may be 0.0005% or more. On the other hand, when the Ta content is more than 0.05%, secondary recrystallization may become unstable. Therefore, the Ta content may be 0.05% or less. The Ta content is preferably 0.04% or less.

### Nb: 0 to 0.010%

Nb (niobium) has an action of stabilizing secondary recrystallization. When such an effect is obtained, the Nb content may be more than 0.0000%, or may be 0.0005% or more. On the other hand, when the Nb content is more than 0.010%, secondary recrystallization may become unstable. Therefore, the Nb content may be 0.010% or less. The Nb content is preferably 0.0050% or less.

### V: 0 to 0.50%

V (vanadium) is an effective element that bonds with N or C to function as an inhibitor. Thus, V may be contained. When such an effect is obtained, the V content is preferably 0.01% or more, and more preferably 0.02% or more.

On the other hand, when the V content exceeds 0.50%, the magnetic characteristics may be deteriorated. Therefore, the V content is 0.50% or less. The V content is preferably 0.30% or less, and more preferably 0.20% or less.

### B: 0 to 0.0200%

B (boron) has an action of stabilizing secondary recrystallization. When such an effect is obtained, the B content may be more than 0.0000%, or may be 0.0005% or more.

On the other hand, when the B content is more than 0.0200%, secondary recrystallization may become unstable. Therefore, the B content may be 0.0200% or less. The B content is preferably 0.0100% or less, and more preferably 0.0050% or less.

### Bi: 0 to 0.0200%

Bi (bismuth) has an effect of improving the magnetic characteristics. Therefore, Bi may be contained. When such an effect is obtained, the Bi content may be more than 0.0000%, or may be 0.0005% or more. On the other hand, when the Bi content is more than 0.0200%, the passability of the sheet during cold rolling may be deteriorated. In addition, when the purification during the final annealing is insufficient and Bi remains excessively, the magnetic characteristics may be adversely affected. Therefore, the Bi content may be 0.0200% or less. The Bi content is preferably 0.0150% or less, and more preferably 0.0100% or less.

### Te: 0 to 0.0200%

Te (tellurium) has an action of stabilizing secondary recrystallization. When such an effect is obtained, the Te content may be more than 0.0000%, or may be 0.0005% or more. When the Te content is more than 0.0200%, fracture may occur during hot rolling or cold rolling. Therefore, the Te content may be 0.0200% or less. The Te content is preferably 0.0150% or less, and more preferably 0.0100% or less.

### Balance: Fe and Impurities

The chemical composition of the base steel sheet of the grain-oriented electrical steel sheet according to the embodiment may contain the above-described elements, with the balance being Fe and impurities. Here, the impurities are contaminated from ore or scrap as a raw material, or from a manufacturing environment or the like when the base steel sheet is industrially manufactured. The impurities mean elements allowed to be included in such a content that the action of the grain-oriented electrical steel sheet according to the embodiment is not adversely affected.

The chemical composition of the slab and the base steel sheet described above may be measured by a general analysis method. For example, the steel components may be measured using Inductively Coupled Plasma-Atomic Emission Spectrometry (ICP-AES). C and S may be measured by a combustion-infrared absorption method, N may be measured by an inert gas fusion-thermal conductivity method, and O may be measured by an inert gas fusion-non-dispersive infrared absorption method.

### (3-2. Configuration and Characteristics of Grain-Oriented Electrical Steel Sheet)

Next, the configuration and characteristics of the grain-oriented electrical steel sheet according to the embodiment will be described.

### <Crystal Orientation>

In the decarburization annealing step as described above, the grain-oriented electrical steel sheet according to the embodiment is subjected to the combination of: precise control of the irradiation conditions of local rapid heating treatment with a laser beam; and control of the oxygen potential in the decarburization annealing step in accordance with the laser beam irradiation conditions. As a result, the obtained grain-oriented electrical steel sheet is sufficiently suppressed in the secondary recrystallization of {211}<011> oriented grains, and can promote the secondary recrystallization of Goss oriented grains, which are superior in magnetic characteristics, and reduce the variation of magnetic characteristics.

Specifically, when measurement points for crystal orientation by an X-ray diffraction method are arranged on the surface of the base steel sheet at a pitch of 6 mm in each of the rolling direction and the direction orthogonal to the rolling direction, measurement points whose orientation difference from {211}<011> is within 15° are included in a percentage of 5% or less with respect to the total measurement points. This can further enhance the magnetic characteristics of the grain-oriented electrical steel sheet.

The method for measuring the crystal orientation is as follows.

A sample of 60 mm×300 mm×sheet thickness is obtained from the grain-oriented electrical steel sheet, and the crystal orientation is measured by the Lauer method. In the Lauer measurement, orientation data is obtained at 171 measurement points at the center portion of the sheet at a pitch of 6 mm in each of the rolling direction and the direction orthogonal to the rolling direction. From the orientation data of all the measurement points, the number of crystal orientation data whose deviation angle from {211}<011> is within 15° is analyzed to calculate the proportion R in all the measurement points (171 points).

### <EPMA Analysis>

As described above, it is considered that there is a correlation between the coating adhesion in the laser beam irradiation part and the formation amount of forsterite as the primary coating. Therefore, in the grain-oriented electrical steel sheet of the embodiment, the formation amount is defined by analysis data of an electron probe microanalyzer (EPMA).

Specifically, as for the grain-oriented electrical steel sheet according to the embodiment, in a line analysis along the rolling direction by EPMA, the obtained oxygen intensity profile at the surface of the primary coating periodically includes a region having a reduced oxygen intensity; and Ioₘᵢₙ is defined as a minimum value of oxygen intensity in the region having a reduced oxygen intensity, Ioₘₐₓ is defined as a maximum value of oxygen intensity in the region other than the region having a reduced oxygen intensity, and the ratio of Ioₘᵢₙ/Ioₘₐₓ is 0.85 or more and 0.96 or less.

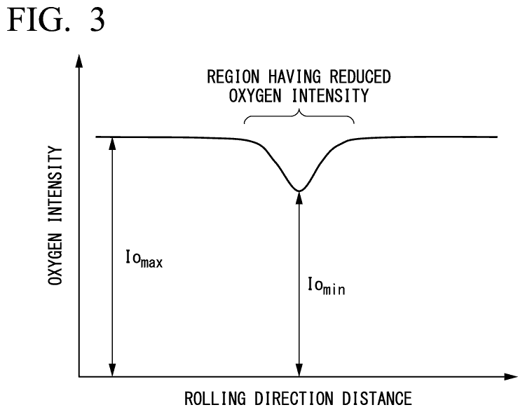

FIG. 3 is a schematic diagram of an oxygen intensity profile measured by EPMA line analysis of the surface of a primary coating. As illustrated in FIG. 3, in the oxygen intensity profile of the surface of the primary coating in the rolling direction measured by EPMA, there is a region having a reduced oxygen intensity in the laser beam irradiation part. This means that the formation amount of forsterite as the primary coating is reduced in the laser beam irradiation part. In the embodiment, since the laser beam is irradiated at an irradiation interval L of 5 to 30 mm, the region having a reduced oxygen intensity also appears at an interval L of 5 to 30 mm.

In the grain-oriented electrical steel sheet according to the embodiment, the reduction amount of oxygen intensity is suppressed in the region having a reduced oxygen intensity. Specifically, Ioₘᵢₙ is defined as the minimum value of O intensity in the region having a reduced oxygen intensity, Ioₘₐₓ is defined as the oxygen intensity in the other region, and the ratio Ioₘᵢₙ/Ioₘₐₓ is 0.85 or more. When Ioₘᵢₙ/Ioₘₐₓ is less than 0.85, the coating adhesion is inferior in the laser beam irradiation part. Therefore, Ioₘᵢₙ/Ioₘₐₓ is 0.85 or more, and preferably 0.87 or more. The upper limit of Ioₘᵢₙ/Ioₘₐₓ is not particularly limited, and may be 1, theoretically. However, the upper limit is about 0.96 when local heating is actually performed by laser beam irradiation. In order to obtain such an oxygen intensity ratio, for example, the heat equalizing process of the decarburization annealing step described above may be performed under an oxygen potential P_{O} of 0.6-0.04 Up or less.

The specific method of the EPMA analysis is as follows.

First, a 50 mm square test piece is obtained from the grain-oriented electrical steel sheet having a secondary coating. The secondary coating is then removed using an alkaline solution. For example, the grain-oriented electrical steel sheet having a secondary coating is immersed in a sodium hydroxide aqueous solution: NaOH: 30 to 50 mass %+H₂O: 50 to 70 mass % at 80 to 90° C. for 5 to 10 minutes, and washed with water and dried after the immersion, thereby removing the secondary coating from the grain-oriented electrical steel sheet.

Next, after the secondary coating is removed, the surface of the primary coating is subjected to line analysis with an EPMA (manufactured by JEOL, JXA-8230) to obtain an oxygen intensity profile. As the analysis conditions of EPMA, the acceleration voltage is 15.0 kV, the irradiation current is 100 nA, the beam shape is a band shape of 10 μm×300 μm, and 3 mm-distance measurement at a step of 10 μm in the rolling direction is continuously performed 15 times (45 mm in total), thereby performing line analysis in the rolling direction. From the obtained measurement data of O intensity in the rolling direction, each 10 sections are calculated for moving average. From the maximum intensity Ioₘₐₓ and the minimum intensity Ioₘᵢₙ, the ratio Ioₘᵢₙ/Ioₘₐₓ is calculated.

The distance for line analysis may be longer than the laser irradiation width in order to observe the region having a reduced oxygen intensity. For example, when the laser irradiation width is 30 mm, the distance for line analysis is 30 mm or more.

### <Sheet Thickness>

The grain-oriented electrical steel sheet according to the embodiment preferably has a sheet thickness of 0.15 to 0.35 mm from the viewpoint of iron loss reduction. In particular, the grain-oriented electrical steel sheet more preferably has a sheet thickness of 0.18 mm or less.

In addition, in the grain-oriented electrical steel sheet according to the embodiment, the base steel sheet preferably has a sheet thickness of 0.14 to 0.22 mm from the viewpoint of iron loss reduction. In particular, the base steel sheet more preferably has a sheet thickness of 0.17 mm or less.

### EXAMPLES

Next, Examples of the present invention will be described, but conditions in Examples are examples of conditions adopted to confirm feasibility and an effect of the present invention, and the present invention is not limited to these examples of conditions. The present invention may adopt various conditions as long as an object of the present invention is achieved without departing from the gist of the present invention.

A slab including, as a chemical composition, components shown in Tables 1A to 1D and a balance including Fe and impurities was prepared. The slab was heated to 1340° C. in a heating furnace. The heated slab was subjected to a hot rolling step to manufacture a hot-rolled steel sheet having a sheet thickness shown in Tables 3A to 3D. Next, the hot-rolled steel sheet was subjected to a hot-band annealing step at a hot-band annealing temperature of 900 to 1200° C. for a holding time of 10 to 300 seconds. After the hot-band annealing, cold rolling step was performed to manufacture a cold-rolled steel sheet having a sheet thicknesses shown in Tables 3A and 3B.

Next, the obtained cold-rolled steel sheet was locally heated with a laser beam in the air atmosphere so that the heated part became a plurality of straight lines each extending such that the angle formed against the rolling direction was an inclination angle (deg.) shown in Tables 3A to 3D, and arranged in the rolling direction at a pitch (interval L) (mm) shown in Tables 3A to 3B. The irradiation conditions are as shown in Tables 3A and 3B.

Next, regardless of whether laser beam heating was performed, the temperature was raised from the temperature range of 400° C. or lower to the temperature range of 750 to 900° C. at an average temperature rising rate shown in Tables 3C to 3D under a nitrogen/hydrogen mixed gas (non-oxidizing atmosphere) having a dew point of −20° C.

After the temperature was raised, decarburization annealing was performed by heat equalization at 850° C. for 120 seconds, where the oxygen potential P_{O} in the annealing atmosphere was as shown in Tables 3C to 3D, thereby obtaining a decarburization-annealed steel sheet.

An annealing separator (water slurry) containing MgO as a main component was applied to the surface of the decarburization-annealed steel sheet. Thereafter, the decarburization-annealed steel sheet coated with the annealing separator was wound into a coil shape. The coil was final annealed to manufacture a final-annealed steel sheet. The final-annealing temperature was 1100° C. to 1200° C., and the final-annealing temperature was held at a holding time of 5 to 30 hours.

The steel sheet after the final annealing step was subjected to a secondary coating forming step (insulating coating forming step).

Specifically, a secondary coating forming agent (insulating coating agent) mainly containing colloidal silica and phosphate was applied onto the surface of each final-annealed steel sheet (on the glass coating), and then the final-annealed steel sheet coated with the secondary coating forming agent was baked to form a secondary coating, as a tension insulating coating, on the primary coating. A grain-oriented electrical steel sheet of each Test No. was manufactured by the above manufacturing steps.

The chemical composition of the base steel sheet was measured by the following component analysis method.

First, the primary coating and the secondary coating were removed from the base steel sheet by the following method. Specifically, the grain-oriented electrical steel sheet formed with a secondary coating was immersed in a sodium hydroxide aqueous solution of NaOH: 30 to 50 mass %+H₂O: 50 to 70 mass % at 80 to 90° C. for 5 to 10 minutes, and after immersion, washed with water, and dried. By this step, the secondary coating was removed from the grain-oriented electrical steel sheet.

Further, the grain-oriented electrical steel sheet from which the secondary coating had been removed and on which the primary coating remained was immersed in high-temperature hydrochloric acid to remove the primary coating. Specifically, the grain-oriented electrical steel sheet on which the primary coating remained was immersed in 30 to 40 mass % hydrochloric acid at 80 to 90° C. for 1 to 5 minutes, and after immersion, washed with water, and dried. Through the above steps, the base steel sheet from which the secondary coating and the primary coating had been removed was obtained.

The chemical composition of the base steel sheet of the grain-oriented electrical steel sheet of each Test Number was measured by the following method.

First, the primary coating and the secondary coating of the grain-oriented electrical steel sheet were removed by the above-described method to extract the base steel sheet. Using the base steel sheet, the chemical composition of the base steel sheet was analyzed based on the following measurement method.

The chemical composition of the obtained steel sheet was measured by a method in accordance with JIS G0321:2017. Specifically, swarf was obtained from the obtained base steel sheet, and the obtained swarf was dissolved in an acid to obtain a solution. Next, the solution was subjected to Inductively Coupled Plasma Atomic Emission Spectrometry (ICP-AES) to perform elemental analysis of chemical composition. The C content and the S content were determined by a well-known high frequency combustion method (combustion-infrared absorption method). The N content was determined using a well-known inert gas fusion-thermal conductivity method. Specifically, measurement was performed using a component analyzer (trade name: ICPS-8000) manufactured by Shimadzu Corporation.

As a result of the analysis, the base steel sheet included, as a chemical composition, components shown in Tables 2A to 2D and a balance including Fe and impurities. In Tables 1A to 1D and Tables 2A to 2D, “0.00”, “0.000”, and “0.0000” indicate that the amount of the corresponding element was less than the detection limit.

### <Evaluation>

The obtained grain-oriented electrical steel sheet was subjected to the following measurements and evaluations.

### [Magnetic Characteristics Measurement]

A test piece was obtained from a coil of the grain-oriented electrical steel sheet of each Test No. The test piece was obtained at 2 positions: at the outer peripheral portion, a position about 10 m from the outer peripheral portion of the final-annealed coil; and at the center portion, a position 50% from the entire length of the coil. The size of the test piece was 60 mm×300 mm×sheet thickness. The test piece included the center portion of the sheet width of the grain-oriented electrical steel sheet. A single-sheet magnetic property test (SST test) was performed in accordance with JIS C2556:2015, and the test piece was applied with a magnetic field of 800 A/m to determine the magnetic flux density B8 (T). The obtained magnetic flux density B8 is shown in “Magnetic flux density B8 (T)” in Tables 1 to 3. A magnetic flux density B8 of 1.902 T or more was evaluated as excellent magnetic properties, and regarded as acceptable.

### [Crystal Orientation Measurement]

After the magnetic characteristics measurement, a sample of 60 mm×300 mm×sheet thickness was subjected to crystal orientation measurement by the Lauer method. In the Lauer measurement, orientation data was acquired in the center portion of the sheet at 171 measurement points at a pitch of 6 mm. From the orientation data of all the measurement points, the number of crystal orientation data whose deviation angle from {211}<011> was within 15° was analyzed to calculate the proportion R in all the measurement points (171 points). Here, the samples whose magnetic flux density B8 was less than 1.700 T in the magnetic characteristics measurement were regarded as being defective in secondary recrystallization, and not subjected to crystal orientation measurement.

### [Coating Adhesion Evaluation]

A test piece was obtained from the grain-oriented electrical steel sheet of each Test No. The test piece was obtained at 2 positions: at the outer peripheral portion, a position about 10 m from the outer peripheral portion of the final-annealed coil; and at the center portion, a position 50% from the entire length of the coil. The test piece had a size of a length of 15 mm in the direction perpendicular to rolling and a length of 60 mm in the rolling direction. The test piece was wound around round bars having various diameters, and the minimum diameter at which peeling of the coating was not visually observed (hereinafter, referred to as bending peeling diameter) was determined, thereby evaluating the coating adhesion. The smaller the bending peeling diameter, the better the coating adhesion. A bending peeling diameter of 40 mm or more was regarded as unacceptable, as the coating is highly likely to be peeled off when an iron core is manufactured.

### [EPMA Analysis (Evaluation of Primary Coating)]

A 50 mm square test piece was obtained from the grain-oriented electrical steel sheet of each Test No. The secondary coating was removed by the method described above. After the secondary coating was removed, the surface of the primary coating was subjected to line analysis with an EPMA (manufactured by JEOL, JXA-8230) to obtain an oxygen intensity profile. As the analysis conditions of EPMA, the acceleration voltage was 15.0 kV, the irradiation current was 100 nA, the beam shape was a band shape of 10 μm×300 μm, and 3 mm-distance measurement at a step of 10 μm in the rolling direction was continuously performed 15 times, thereby performing line analysis in the rolling direction. From the obtained measurement data of oxygen intensity in the rolling direction, each 10 sections were calculated for moving average. From the maximum intensity Ioₘₐₓ and the minimum intensity Ioₘᵢₙ, the ratio Ioₘᵢₙ/Ioₘₐₓ was calculated.

### <Evaluation Results>

The sheet thickness and composition of the grain-oriented electrical steel sheets were as shown in Tables 2A to 2D.

The results of magnetic characteristics measurement, crystal orientation measurement, and coating adhesion evaluation of the grain-oriented electrical steel sheet are shown in Tables 3E to 3F. When the magnetic flux density B8 was less than 1.700 T, crystal orientation measurement and coating adhesion evaluation were not performed, and thus blank fields are used.

Test Nos. 1 to 30 were appropriate under all conditions. Therefore, the magnetic flux density B8 was 1.902 T or more at the center portion and outer peripheral portion of the coil, and the abundance ratio of magnetic inferior grains, {211}<011>, was 5% or less. In addition, since Ioₘᵢₙ/Ioₘₐₓ was 0.85 to 0.96, the bending peeling diameter was 30 mm or less, and good coating adhesion was exhibited.

Test Nos. 31, 32, 51, and 52 were not appropriate in rolling reduction. In Test Nos. 31 and 51, in which the rolling reduction was less than 89%, the ratio of {211}<011> was low, but the magnetic flux density B8 was low. This is presumably because the amount of the Goss orientation was large, but the deviation angle was large due to low rolling reduction. On the other hand, in Test Nos. 32 and 52, in which the rolling reduction was 94% or higher, the ratio of {211}<011> was high, and the magnetic flux density B8 was low. It is considered that since the rolling reduction was high, {211}<011> was developed during cold rolling, and secondary recrystallization easily occurred.

Test Nos. 33, 34, 53, and 54 were not heated with a laser beam. Test Nos. 33 and 53 had a low temperature rising rate in the decarburization annealing step as the subsequent step, and was remarkably low in the magnetic flux density B8. Test Nos. 34 and 54 had a high temperature rising rate in the decarburization annealing step as the subsequent step, but has a high {211}<011> ratio, and therefore was inferior in the magnetic flux density B8. It is considered that since heating with a laser beam was not performed, the Goss orientation was not sufficiently obtained and {211}<011> was secondarily recrystallized.

Test Nos. 35, 36, 55, and 56 were heated with a laser beam, but had inappropriate Up. Test Nos. 35 and 55, whose Up was 0 or less, were insufficiently heated with a laser beam, and therefore the amount of {211}<011> was large, and the magnetic flux density B8 was low. Test Nos. 36 and 56, whose Up was 6 or more, were excessively heated with a laser beam, and therefore, the amount of {211}<011> was small, but the magnetic flux density was low. This is presumably because the precipitates in the laser beam irradiation part were coarsened by excessive heating, and the secondary recrystallization of Goss orientation grains from the laser beam irradiation part occurred without orientation selectivity.

Test Nos. 37, 38, 57, and 58 were heated with a laser beam, but the irradiation interval was inappropriate. Therefore, the magnetic flux density B8 was low. The abundance ratio of the crystal orientation whose deviation angle from {211}<011> was within 15° was also 5% or more. This is presumably because the effect of enriching Goss oriented grains by a laser beam was insufficient.

Test Nos. 39, 40, 59, and 60 were heated with a laser beam, but the inclination of the irradiation part was inappropriate. Although the amount of {211}<011> was small, the magnetic flux density B8 was low.

Although the reason is unknown, it is considered that, when the inclination of the irradiation part is inappropriate, also the secondary recrystallization of Goss oriented grains having large deviation frequently occurs, and the secondary recrystallization of {211}<011> is suppressed, but Goss oriented grains lost orientation selectivity. Test Nos. 41, 42, 61, and 62 had an inappropriate temperature rising rate in the ACL temperature rising process. When the temperature rising rate was less than 80° C./s, the effect of enriching Goss oriented grains appeared insufficient even when a laser beam was applied, and the amount of {211}<011> was large, and the magnetic flux density B8 was low. When the temperature rising rate was higher than 2000° C./s, the number of grains with coincidence site lattice orientation was reduced, and therefore Goss oriented grains were reduced in selective growth, thereby the magnetic flux density B8 was low.

Since Test Nos. 43 to 50 and 63 to 70 had an inappropriate oxygen potential P_{O} in the ACL heat equalizing process, the magnetic characteristics were good, but the coating adhesion deteriorated. When P_{O} was less than 0.3, Ioₘᵢₙ/Ioₘₐₓ was 0.97 or more. It is considered that oxidation was insufficient in the decarburization annealing step, and the primary coating was insufficiently formed during final annealing, thereby the coating adhesion deteriorated. When P_{O} exceeded 0.6-0.04 Up, Ioₘᵢₙ/Ioₘₐₓ was less than 0.85, and the coating adhesion was inferior near the laser beam irradiation part.

TABLE 1A

| Steel | Chemical composition of slab (mass %, balance: Fe and impurities) | | | | | | | | | | |
|---|---|---|---|---|---|---|---|---|---|---|---|
| No. | Si | Mn | N | C | sol. Al | S | Se | S + Se | Ti | Ni | Cu |
| 1 | 3.25 | 0.05 | 0.0080 | 0.064 | 0.020 | 0.022 | 0.000 | 0.022 | 0.002 | 0.00 | 0.00 |
| 2 | 3.31 | 0.07 | 0.0045 | 0.035 | 0.018 | 0.018 | 0.002 | 0.020 | 0.002 | 0.00 | 0.00 |
| 3 | 3.45 | 0.08 | 0.0065 | 0.089 | 0.010 | 0.014 | 0.000 | 0.014 | 0.002 | 0.00 | 0.00 |
| 4 | 3.28 | 0.08 | 0.0150 | 0.066 | 0.034 | 0.018 | 0.000 | 0.018 | 0.003 | 0.00 | 0.00 |
| 5 | 3.16 | 0.14 | 0.0094 | 0.085 | 0.050 | 0.016 | 0.004 | 0.020 | 0.002 | 0.00 | 0.00 |
| 6 | 3.15 | 0.10 | 0.0083 | 0.092 | 0.026 | 0.020 | 0.000 | 0.020 | 0.001 | 0.00 | 0.00 |
| 7 | 3.25 | 0.30 | 0.0075 | 0.074 | 0.028 | 0.028 | 0.000 | 0.028 | 0.008 | 0.00 | 0.00 |
| 8 | 3.64 | 0.18 | 0.0041 | 0.066 | 0.032 | 0.018 | 0.012 | 0.030 | 0.001 | 0.00 | 0.00 |
| 9 | 2.95 | 0.12 | 0.0030 | 0.082 | 0.032 | 0.022 | 0.000 | 0.022 | 0.002 | 0.00 | 0.00 |
| 10 | 2.50 | 0.09 | 0.0055 | 0.015 | 0.032 | 0.050 | 0.000 | 0.050 | 0.002 | 0.00 | 0.00 |
| 11 | 3.45 | 0.10 | 0.0083 | 0.069 | 0.024 | 0.026 | 0.000 | 0.026 | 0.003 | 0.00 | 0.00 |
| 12 | 4.00 | 0.06 | 0.0099 | 0.021 | 0.018 | 0.034 | 0.012 | 0.046 | 0.002 | 0.00 | 0.00 |
| 13 | 3.45 | 0.04 | 0.0134 | 0.010 | 0.024 | 0.016 | 0.000 | 0.016 | 0.002 | 0.00 | 0.00 |
| 14 | 3.55 | 0.01 | 0.0082 | 0.083 | 0.012 | 0.020 | 0.000 | 0.020 | 0.002 | 0.00 | 0.00 |
| 15 | 3.42 | 0.05 | 0.0084 | 0.090 | 0.044 | 0.028 | 0.021 | 0.049 | 0.002 | 0.00 | 0.00 |
| 16 | 3.38 | 0.07 | 0.0065 | 0.061 | 0.048 | 0.018 | 0.000 | 0.018 | 0.001 | 0.00 | 0.00 |
| 17 | 3.29 | 0.08 | 0.0045 | 0.077 | 0.024 | 0.010 | 0.000 | 0.010 | 0.001 | 0.00 | 0.00 |
| 18 | 3.24 | 0.14 | 0.0056 | 0.083 | 0.026 | 0.042 | 0.000 | 0.042 | 0.003 | 0.00 | 0.00 |
| 19 | 3.26 | 0.10 | 0.0032 | 0.092 | 0.016 | 0.004 | 0.006 | 0.010 | 0.002 | 0.00 | 0.00 |
| 20 | 3.33 | 0.09 | 0.0078 | 0.034 | 0.032 | 0.026 | 0.000 | 0.026 | 0.002 | 0.03 | 0.07 |
| 21 | 3.21 | 0.08 | 0.0082 | 0.091 | 0.024 | 0.021 | 0.000 | 0.021 | 0.003 | 0.00 | 0.00 |
| 22 | 3.38 | 0.08 | 0.0079 | 0.076 | 0.025 | 0.024 | 0.000 | 0.024 | 0.004 | 0.02 | 0.02 |
| 23 | 3.45 | 0.09 | 0.0093 | 0.100 | 0.034 | 0.018 | 0.000 | 0.018 | 0.002 | 0.00 | 0.00 |
| 24 | 3.21 | 0.08 | 0.0121 | 0.038 | 0.036 | 0.016 | 0.000 | 0.016 | 0.004 | 0.00 | 0.13 |
| 25 | 3.18 | 0.13 | 0.0100 | 0.045 | 0.028 | 0.020 | 0.004 | 0.024 | 0.005 | 0.08 | 0.00 |
| 26 | 3.02 | 0.15 | 0.0087 | 0.084 | 0.021 | 0.028 | 0.000 | 0.028 | 0.002 | 0.00 | 0.09 |
| 27 | 3.22 | 0.04 | 0.0082 | 0.076 | 0.022 | 0.018 | 0.000 | 0.018 | 0.002 | 0.15 | 0.00 |
| 28 | 3.32 | 0.07 | 0.0082 | 0.078 | 0.024 | 0.022 | 0.000 | 0.022 | 0.002 | 0.00 | 0.09 |
| 29 | 3.39 | 0.09 | 0.0081 | 0.082 | 0.033 | 0.031 | 0.002 | 0.033 | 0.003 | 0.02 | 0.00 |
| 30 | 3.45 | 0.08 | 0.0084 | 0.088 | 0.031 | 0.022 | 0.000 | 0.022 | 0.003 | 0.00 | 0.00 |
| 31 | 3.35 | 0.08 | 0.0079 | 0.073 | 0.025 | 0.024 | 0.000 | 0.024 | 0.003 | 0.00 | 0.00 |
| 32 | 3.40 | 0.08 | 0.0081 | 0.071 | 0.026 | 0.022 | 0.000 | 0.022 | 0.001 | 0.00 | 0.00 |
| 33 | 3.34 | 0.06 | 0.0040 | 0.085 | 0.048 | 0.012 | 0.000 | 0.012 | 0.001 | 0.00 | 0.00 |
| 34 | 3.26 | 0.04 | 0.0071 | 0.078 | 0.042 | 0.024 | 0.000 | 0.024 | 0.002 | 0.00 | 0.00 |
| 35 | 3.33 | 0.04 | 0.0072 | 0.085 | 0.024 | 0.031 | 0.000 | 0.031 | 0.002 | 0.00 | 0.00 |
| 36 | 3.33 | 0.08 | 0.0079 | 0.091 | 0.010 | 0.048 | 0.000 | 0.048 | 0.002 | 0.00 | 0.00 |
| 37 | 2.99 | 0.01 | 0.0094 | 0.099 | 0.031 | 0.023 | 0.002 | 0.025 | 0.002 | 0.00 | 0.00 |
| 38 | 3.40 | 0.05 | 0.0145 | 0.045 | 0.033 | 0.023 | 0.000 | 0.023 | 0.003 | 0.00 | 0.00 |

TABLE 1B

| Steel | Chemical composition of slab (mass %, balance: Fe and impurities) | | | | | | | | | | |
|---|---|---|---|---|---|---|---|---|---|---|---|
| No. | Si | Mn | N | C | sol. Al | S | Se | S + Se | Ti | Ni | Cu |
| 39 | 3.21 | 0.07 | 0.0114 | 0.052 | 0.018 | 0.008 | 0.015 | 0.023 | 0.002 | 0.00 | 0.00 |
| 40 | 2.54 | 0.07 | 0.0082 | 0.042 | 0.022 | 0.018 | 0.000 | 0.018 | 0.002 | 0.00 | 0.00 |
| 41 | 3.45 | 0.08 | 0.0030 | 0.076 | 0.020 | 0.025 | 0.000 | 0.025 | 0.001 | 0.00 | 0.00 |
| 42 | 3.25 | 0.22 | 0.0064 | 0.089 | 0.020 | 0.018 | 0.012 | 0.030 | 0.002 | 0.00 | 0.00 |
| 43 | 3.21 | 0.06 | 0.0077 | 0.044 | 0.026 | 0.011 | 0.000 | 0.011 | 0.002 | 0.00 | 0.00 |
| 44 | 3.45 | 0.10 | 0.0079 | 0.076 | 0.024 | 0.022 | 0.000 | 0.022 | 0.002 | 0.00 | 0.00 |
| 45 | 3.29 | 0.04 | 0.0071 | 0.071 | 0.020 | 0.022 | 0.000 | 0.022 | 0.003 | 0.00 | 0.00 |
| 46 | 3.21 | 0.09 | 0.0042 | 0.071 | 0.031 | 0.018 | 0.000 | 0.018 | 0.002 | 0.00 | 0.00 |
| 47 | 3.25 | 0.14 | 0.0092 | 0.092 | 0.014 | 0.022 | 0.000 | 0.022 | 0.004 | 0.00 | 0.00 |
| 48 | 3.44 | 0.09 | 0.0101 | 0.062 | 0.022 | 0.029 | 0.000 | 0.029 | 0.002 | 0.00 | 0.00 |
| 49 | 3.43 | 0.10 | 0.0084 | 0.072 | 0.024 | 0.027 | 0.000 | 0.027 | 0.001 | 0.00 | 0.00 |
| 50 | 3.51 | 0.08 | 0.0090 | 0.023 | 0.029 | 0.032 | 0.000 | 0.032 | 0.002 | 0.00 | 0.00 |
| 51 | 3.25 | 0.07 | 0.0088 | 0.072 | 0.025 | 0.023 | 0.000 | 0.023 | 0.002 | 0.00 | 0.06 |
| 52 | 3.21 | 0.08 | 0.0083 | 0.069 | 0.028 | 0.021 | 0.004 | 0.025 | 0.002 | 0.02 | 0.04 |
| 53 | 3.78 | 0.08 | 0.0081 | 0.078 | 0.012 | 0.011 | 0.000 | 0.011 | 0.002 | 0.00 | 0.00 |
| 54 | 3.23 | 0.18 | 0.0068 | 0.077 | 0.021 | 0.010 | 0.000 | 0.010 | 0.006 | 0.01 | 0.07 |
| 55 | 3.41 | 0.04 | 0.0121 | 0.023 | 0.025 | 0.019 | 0.005 | 0.024 | 0.004 | 0.00 | 0.00 |
| 56 | 3.44 | 0.06 | 0.0081 | 0.031 | 0.024 | 0.048 | 0.000 | 0.048 | 0.003 | 0.00 | 0.00 |
| 57 | 3.11 | 0.01 | 0.0086 | 0.066 | 0.033 | 0.031 | 0.000 | 0.031 | 0.006 | 0.04 | 0.00 |
| 58 | 2.82 | 0.09 | 0.0088 | 0.080 | 0.024 | 0.029 | 0.000 | 0.029 | 0.002 | 0.00 | 0.00 |
| 59 | 3.95 | 0.08 | 0.0092 | 0.090 | 0.029 | 0.030 | 0.014 | 0.044 | 0.001 | 0.01 | 0.00 |
| 60 | 2.55 | 0.08 | 0.0148 | 0.082 | 0.020 | 0.024 | 0.000 | 0.024 | 0.001 | 0.00 | 0.06 |
| 61 | 2.99 | 0.29 | 0.0100 | 0.071 | 0.029 | 0.021 | 0.000 | 0.021 | 0.002 | 0.00 | 0.00 |
| 62 | 3.25 | 0.21 | 0.0088 | 0.055 | 0.029 | 0.022 | 0.000 | 0.022 | 0.002 | 0.00 | 0.14 |
| 63 | 3.24 | 0.08 | 0.0082 | 0.043 | 0.024 | 0.024 | 0.000 | 0.024 | 0.001 | 0.02 | 0.05 |
| 64 | 3.33 | 0.07 | 0.0081 | 0.085 | 0.024 | 0.020 | 0.000 | 0.020 | 0.002 | 0.00 | 0.00 |
| 65 | 3.51 | 0.04 | 0.0077 | 0.065 | 0.027 | 0.032 | 0.000 | 0.032 | 0.002 | 0.04 | 0.04 |
| 66 | 3.51 | 0.11 | 0.0081 | 0.077 | 0.027 | 0.024 | 0.000 | 0.024 | 0.004 | 0.00 | 0.07 |
| 67 | 3.45 | 0.16 | 0.0088 | 0.068 | 0.027 | 0.033 | 0.002 | 0.035 | 0.002 | 0.09 | 0.00 |
| 68 | 2.99 | 0.14 | 0.0109 | 0.077 | 0.021 | 0.018 | 0.000 | 0.018 | 0.001 | 0.02 | 0.00 |
| 69 | 3.20 | 0.12 | 0.0099 | 0.074 | 0.022 | 0.022 | 0.000 | 0.022 | 0.001 | 0.00 | 0.07 |
| 70 | 3.41 | 0.05 | 0.0079 | 0.088 | 0.019 | 0.048 | 0.000 | 0.048 | 0.002 | 0.00 | 0.00 |
| 71 | 3.24 | 0.08 | 0.0092 | 0.079 | 0.024 | 0.021 | 0.000 | 0.028 | 0.002 | 0.00 | 0.09 |
| 72 | 3.19 | 0.07 | 0.0084 | 0.076 | 0.025 | 0.022 | 0.000 | 0.018 | 0.003 | 0.15 | 0.07 |
| 73 | 3.35 | 0.08 | 0.0083 | 0.077 | 0.024 | 0.024 | 0.001 | 0.025 | 0.002 | 0.04 | 0.04 |
| 74 | 3.33 | 0.08 | 0.0079 | 0.076 | 0.024 | 0.022 | 0.000 | 0.011 | 0.002 | 0.00 | 0.00 |
| 75 | 3.42 | 0.08 | 0.0076 | 0.081 | 0.023 | 0.023 | 0.000 | 0.032 | 0.002 | 0.03 | 0.04 |
| 76 | 3.39 | 0.07 | 0.0079 | 0.069 | 0.026 | 0.024 | 0.000 | 0.024 | 0.003 | 0.00 | 0.07 |

TABLE 1C

| Steel | Chemical composition of slab (mass %, balance: Fe and impurities) | | | | | | | | | | |
|---|---|---|---|---|---|---|---|---|---|---|---|
| No. | Sb | Sn | Cr | P | Mo | Ta | Nb | V | B | Te | Bi |
| 1 | 0.00 | 0.00 | 0.00 | 0.00 | 0.00 | 0.00 | 0.000 | 0.00 | 0.000 | 0.0000 | 0.0000 |
| 2 | 0.00 | 0.00 | 0.00 | 0.00 | 0.00 | 0.00 | 0.000 | 0.00 | 0.000 | 0.0000 | 0.0000 |
| 3 | 0.00 | 0.00 | 0.00 | 0.00 | 0.00 | 0.00 | 0.000 | 0.00 | 0.000 | 0.0000 | 0.0000 |
| 4 | 0.00 | 0.00 | 0.00 | 0.00 | 0.00 | 0.00 | 0.000 | 0.00 | 0.000 | 0.0000 | 0.0000 |
| 5 | 0.00 | 0.00 | 0.00 | 0.00 | 0.00 | 0.00 | 0.000 | 0.00 | 0.000 | 0.0000 | 0.0000 |
| 6 | 0.00 | 0.00 | 0.00 | 0.00 | 0.00 | 0.00 | 0.000 | 0.00 | 0.000 | 0.0000 | 0.0000 |
| 7 | 0.00 | 0.00 | 0.00 | 0.00 | 0.00 | 0.00 | 0.000 | 0.00 | 0.000 | 0.0000 | 0.0000 |
| 8 | 0.00 | 0.00 | 0.00 | 0.00 | 0.00 | 0.00 | 0.000 | 0.00 | 0.000 | 0.0000 | 0.0000 |
| 9 | 0.00 | 0.00 | 0.00 | 0.00 | 0.00 | 0.00 | 0.000 | 0.00 | 0.000 | 0.0000 | 0.0000 |
| 10 | 0.00 | 0.00 | 0.00 | 0.00 | 0.00 | 0.00 | 0.000 | 0.00 | 0.000 | 0.0000 | 0.0000 |
| 11 | 0.00 | 0.00 | 0.00 | 0.00 | 0.00 | 0.00 | 0.000 | 0.00 | 0.000 | 0.0000 | 0.0000 |
| 12 | 0.00 | 0.00 | 0.00 | 0.00 | 0.00 | 0.00 | 0.000 | 0.00 | 0.000 | 0.0000 | 0.0000 |
| 13 | 0.00 | 0.00 | 0.00 | 0.00 | 0.00 | 0.00 | 0.000 | 0.00 | 0.000 | 0.0000 | 0.0000 |
| 14 | 0.00 | 0.00 | 0.00 | 0.00 | 0.00 | 0.00 | 0.000 | 0.00 | 0.000 | 0.0000 | 0.0000 |
| 15 | 0.00 | 0.00 | 0.00 | 0.00 | 0.00 | 0.00 | 0.000 | 0.00 | 0.000 | 0.0000 | 0.0000 |
| 16 | 0.00 | 0.00 | 0.00 | 0.00 | 0.00 | 0.00 | 0.000 | 0.00 | 0.000 | 0.0000 | 0.0000 |
| 17 | 0.00 | 0.00 | 0.00 | 0.00 | 0.00 | 0.00 | 0.000 | 0.00 | 0.000 | 0.0000 | 0.0000 |
| 18 | 0.00 | 0.00 | 0.00 | 0.00 | 0.00 | 0.00 | 0.000 | 0.00 | 0.000 | 0.0000 | 0.0000 |
| 19 | 0.01 | 0.00 | 0.00 | 0.00 | 0.00 | 0.01 | 0.000 | 0.00 | 0.000 | 0.0000 | 0.0200 |
| 20 | 0.00 | 0.10 | 0.07 | 0.00 | 0.05 | 0.00 | 0.000 | 0.01 | 0.000 | 0.0000 | 0.0000 |
| 21 | 0.02 | 0.00 | 0.00 | 0.01 | 0.00 | 0.00 | 0.000 | 0.00 | 0.001 | 0.0001 | 0.0000 |
| 22 | 0.00 | 0.08 | 0.04 | 0.00 | 0.02 | 0.00 | 0.000 | 0.04 | 0.002 | 0.0000 | 0.0020 |
| 23 | 0.01 | 0.00 | 0.00 | 0.00 | 0.00 | 0.00 | 0.001 | 0.00 | 0.000 | 0.0012 | 0.0000 |
| 24 | 0.00 | 0.12 | 0.14 | 0.01 | 0.01 | 0.00 | 0.001 | 0.00 | 0.000 | 0.0000 | 0.0005 |
| 25 | 0.00 | 0.00 | 0.00 | 0.04 | 0.00 | 0.03 | 0.000 | 0.00 | 0.000 | 0.0142 | 0.0000 |
| 26 | 0.00 | 0.24 | 0.03 | 0.00 | 0.02 | 0.00 | 0.000 | 0.00 | 0.000 | 0.0000 | 0.0035 |
| 27 | 0.00 | 0.00 | 0.00 | 0.02 | 0.00 | 0.00 | 0.002 | 0.00 | 0.002 | 0.0000 | 0.0000 |
| 28 | 0.00 | 0.14 | 0.06 | 0.00 | 0.01 | 0.00 | 0.000 | 0.01 | 0.000 | 0.0000 | 0.0080 |
| 29 | 0.00 | 0.00 | 0.00 | 0.01 | 0.00 | 0.01 | 0.000 | 0.00 | 0.000 | 0.0000 | 0.0000 |
| 30 | 0.00 | 0.00 | 0.24 | 0.00 | 0.00 | 0.00 | 0.000 | 0.00 | 0.000 | 0.0000 | 0.0000 |
| 31 | 0.00 | 0.00 | 0.00 | 0.00 | 0.00 | 0.00 | 0.000 | 0.00 | 0.000 | 0.0000 | 0.0000 |
| 32 | 0.00 | 0.00 | 0.00 | 0.00 | 0.00 | 0.00 | 0.000 | 0.00 | 0.000 | 0.0000 | 0.0000 |
| 33 | 0.00 | 0.00 | 0.00 | 0.00 | 0.00 | 0.00 | 0.000 | 0.00 | 0.000 | 0.0000 | 0.0000 |
| 34 | 0.00 | 0.00 | 0.00 | 0.00 | 0.00 | 0.00 | 0.000 | 0.00 | 0.000 | 0.0000 | 0.0000 |
| 35 | 0.00 | 0.00 | 0.00 | 0.00 | 0.00 | 0.00 | 0.000 | 0.00 | 0.000 | 0.0000 | 0.0000 |
| 36 | 0.00 | 0.00 | 0.00 | 0.00 | 0.00 | 0.00 | 0.000 | 0.00 | 0.000 | 0.0000 | 0.0000 |
| 37 | 0.00 | 0.00 | 0.00 | 0.00 | 0.00 | 0.00 | 0.000 | 0.00 | 0.000 | 0.0000 | 0.0000 |
| 38 | 0.00 | 0.00 | 0.00 | 0.00 | 0.00 | 0.00 | 0.000 | 0.00 | 0.000 | 0.0000 | 0.0000 |

TABLE 1D

| Steel | Chemical composition of slab (mass %, balance: Fe and impurities) | | | | | | | | | | |
|---|---|---|---|---|---|---|---|---|---|---|---|
| No. | Sb | Sn | Cr | P | Mo | Ta | Nb | V | B | Te | Bi |
| 39 | 0.00 | 0.00 | 0.00 | 0.00 | 0.00 | 0.00 | 0.000 | 0.00 | 0.000 | 0.0000 | 0.0000 |
| 40 | 0.00 | 0.00 | 0.00 | 0.00 | 0.00 | 0.00 | 0.000 | 0.00 | 0.000 | 0.0000 | 0.0000 |
| 41 | 0.00 | 0.00 | 0.00 | 0.00 | 0.00 | 0.00 | 0.000 | 0.00 | 0.000 | 0.0000 | 0.0000 |
| 42 | 0.00 | 0.00 | 0.00 | 0.00 | 0.00 | 0.00 | 0.000 | 0.00 | 0.000 | 0.0000 | 0.0000 |
| 43 | 0.00 | 0.00 | 0.00 | 0.00 | 0.00 | 0.00 | 0.000 | 0.00 | 0.000 | 0.0000 | 0.0000 |
| 44 | 0.00 | 0.00 | 0.00 | 0.00 | 0.00 | 0.00 | 0.000 | 0.00 | 0.000 | 0.0000 | 0.0000 |
| 45 | 0.00 | 0.00 | 0.00 | 0.00 | 0.00 | 0.00 | 0.000 | 0.00 | 0.000 | 0.0000 | 0.0000 |
| 46 | 0.00 | 0.00 | 0.00 | 0.00 | 0.00 | 0.00 | 0.000 | 0.00 | 0.000 | 0.0000 | 0.0000 |
| 47 | 0.00 | 0.00 | 0.00 | 0.00 | 0.00 | 0.00 | 0.000 | 0.00 | 0.000 | 0.0000 | 0.0000 |
| 48 | 0.00 | 0.00 | 0.00 | 0.00 | 0.00 | 0.00 | 0.000 | 0.00 | 0.000 | 0.0000 | 0.0000 |
| 49 | 0.00 | 0.00 | 0.00 | 0.00 | 0.00 | 0.00 | 0.000 | 0.00 | 0.000 | 0.0000 | 0.0000 |
| 50 | 0.00 | 0.00 | 0.00 | 0.00 | 0.00 | 0.00 | 0.000 | 0.00 | 0.000 | 0.0000 | 0.0000 |
| 51 | 0.01 | 0.08 | 0.00 | 0.02 | 0.01 | 0.00 | 0.001 | 0.00 | 0.000 | 0.0000 | 0.0005 |
| 52 | 0.00 | 0.00 | 0.00 | 0.04 | 0.00 | 0.03 | 0.000 | 0.00 | 0.000 | 0.0000 | 0.0011 |
| 53 | 0.00 | 0.00 | 0.00 | 0.00 | 0.00 | 0.04 | 0.002 | 0.00 | 0.001 | 0.0000 | 0.0000 |
| 54 | 0.00 | 0.21 | 0.00 | 0.00 | 0.00 | 0.00 | 0.000 | 0.00 | 0.000 | 0.0087 | 0.0000 |
| 55 | 0.08 | 0.00 | 0.00 | 0.01 | 0.01 | 0.00 | 0.000 | 0.05 | 0.000 | 0.0000 | 0.0022 |
| 56 | 0.00 | 0.00 | 0.02 | 0.00 | 0.02 | 0.00 | 0.001 | 0.00 | 0.001 | 0.0000 | 0.0000 |
| 57 | 0.00 | 0.11 | 0.00 | 0.02 | 0.00 | 0.00 | 0.000 | 0.00 | 0.000 | 0.0014 | 0.0010 |
| 58 | 0.00 | 0.00 | 0.00 | 0.00 | 0.00 | 0.01 | 0.000 | 0.01 | 0.000 | 0.0000 | 0.0000 |
| 59 | 0.01 | 0.00 | 0.00 | 0.02 | 0.00 | 0.00 | 0.000 | 0.00 | 0.002 | 0.0000 | 0.0000 |
| 60 | 0.00 | 0.00 | 0.05 | 0.00 | 0.00 | 0.00 | 0.001 | 0.00 | 0.000 | 0.0000 | 0.0000 |
| 61 | 0.03 | 0.00 | 0.00 | 0.00 | 0.04 | 0.00 | 0.000 | 0.14 | 0.000 | 0.0002 | 0.0000 |
| 62 | 0.00 | 0.00 | 0.00 | 0.02 | 0.00 | 0.00 | 0.000 | 0.00 | 0.000 | 0.0000 | 0.0000 |
| 63 | 0.00 | 0.10 | 0.02 | 0.00 | 0.00 | 0.00 | 0.000 | 0.00 | 0.001 | 0.0001 | 0.0000 |
| 64 | 0.01 | 0.02 | 0.04 | 0.00 | 0.00 | 0.00 | 0.000 | 0.00 | 0.000 | 0.0000 | 0.0009 |
| 65 | 0.00 | 0.00 | 0.04 | 0.00 | 0.00 | 0.00 | 0.000 | 0.08 | 0.000 | 0.0000 | 0.0000 |
| 66 | 0.00 | 0.00 | 0.00 | 0.04 | 0.00 | 0.00 | 0.003 | 0.00 | 0.000 | 0.0000 | 0.0014 |
| 67 | 0.00 | 0.00 | 0.04 | 0.00 | 0.00 | 0.02 | 0.000 | 0.00 | 0.001 | 0.0000 | 0.0140 |
| 68 | 0.00 | 0.20 | 0.00 | 0.03 | 0.01 | 0.00 | 0.000 | 0.00 | 0.000 | 0.0000 | 0.0000 |
| 69 | 0.00 | 0.12 | 0.08 | 0.00 | 0.00 | 0.00 | 0.000 | 0.00 | 0.000 | 0.0000 | 0.0021 |
| 70 | 0.00 | 0.00 | 0.00 | 0.00 | 0.00 | 0.02 | 0.000 | 0.00 | 0.000 | 0.0000 | 0.0000 |
| 71 | 0.00 | 0.24 | 0.03 | 0.00 | 0.02 | 0.00 | 0.000 | 0.00 | 0.000 | 0.0000 | 0.0029 |
| 72 | 0.01 | 0.12 | 0.00 | 0.02 | 0.00 | 0.00 | 0.001 | 0.00 | 0.001 | 0.0005 | 0.0000 |
| 73 | 0.00 | 0.00 | 0.03 | 0.01 | 0.01 | 0.01 | 0.000 | 0.00 | 0.000 | 0.0000 | 0.0015 |
| 74 | 0.00 | 0.10 | 0.06 | 0.00 | 0.00 | 0.01 | 0.002 | 0.00 | 0.000 | 0.0000 | 0.0000 |
| 75 | 0.00 | 0.00 | 0.04 | 0.00 | 0.00 | 0.00 | 0.000 | 0.08 | 0.000 | 0.0000 | 0.0000 |
| 76 | 0.00 | 0.08 | 0.00 | 0.01 | 0.00 | 0.00 | 0.001 | 0.00 | 0.000 | 0.0000 | 0.0009 |

TABLE 2A

| | Sheet thickness | Chemical composition of grain-oriented electrical steel sheet | | | | | | | | | | |
|---|---|---|---|---|---|---|---|---|---|---|---|---|
| Steel | of product | (mass %, balance: Fe and impurities) | | | | | | | | | | |
| No. | [mm] | Si | Mn | N | C | Sol. Al | S | Se | S + Se | Ti | Ni | Cu |
| 1 | 0.18 | 3.23 | 0.05 | 0.0024 | 0.002 | 0.000 | 0.000 | 0.000 | 0.000 | 0.002 | 0.00 | 0.00 |
| 2 | 0.18 | 3.29 | 0.07 | 0.0018 | 0.002 | 0.000 | 0.000 | 0.000 | 0.000 | 0.002 | 0.00 | 0.00 |
| 3 | 0.18 | 3.44 | 0.08 | 0.0012 | 0.002 | 0.000 | 0.000 | 0.000 | 0.000 | 0.002 | 0.00 | 0.00 |
| 4 | 0.18 | 3.27 | 0.08 | 0.0042 | 0.002 | 0.000 | 0.000 | 0.000 | 0.000 | 0.003 | 0.00 | 0.00 |
| 5 | 0.18 | 3.15 | 0.14 | 0.0014 | 0.002 | 0.000 | 0.000 | 0.000 | 0.000 | 0.002 | 0.00 | 0.00 |
| 6 | 0.18 | 3.14 | 0.10 | 0.0010 | 0.001 | 0.000 | 0.000 | 0.000 | 0.000 | 0.001 | 0.00 | 0.00 |
| 7 | 0.18 | 3.23 | 0.30 | 0.0004 | 0.002 | 0.000 | 0.000 | 0.000 | 0.000 | 0.008 | 0.00 | 0.00 |
| 8 | 0.18 | 3.61 | 0.18 | 0.0008 | 0.002 | 0.000 | 0.000 | 0.000 | 0.000 | 0.001 | 0.00 | 0.00 |
| 9 | 0.18 | 2.93 | 0.12 | 0.0018 | 0.002 | 0.000 | 0.000 | 0.000 | 0.000 | 0.002 | 0.00 | 0.00 |
| 10 | 0.18 | 2.50 | 0.09 | 0.0024 | 0.002 | 0.000 | 0.000 | 0.000 | 0.000 | 0.002 | 0.00 | 0.00 |
| 11 | 0.18 | 3.42 | 0.10 | 0.0010 | 0.002 | 0.000 | 0.000 | 0.000 | 0.000 | 0.003 | 0.00 | 0.00 |
| 12 | 0.18 | 3.98 | 0.06 | 0.0011 | 0.001 | 0.001 | 0.001 | 0.000 | 0.001 | 0.002 | 0.00 | 0.00 |
| 13 | 0.18 | 3.43 | 0.04 | 0.0032 | 0.002 | 0.000 | 0.000 | 0.000 | 0.000 | 0.002 | 0.00 | 0.00 |
| 14 | 0.18 | 3.53 | 0.01 | 0.0014 | 0.002 | 0.000 | 0.000 | 0.000 | 0.000 | 0.002 | 0.00 | 0.00 |
| 15 | 0.18 | 3.39 | 0.05 | 0.0016 | 0.002 | 0.000 | 0.000 | 0.001 | 0.001 | 0.002 | 0.00 | 0.00 |
| 16 | 0.18 | 3.34 | 0.07 | 0.0004 | 0.002 | 0.000 | 0.000 | 0.000 | 0.000 | 0.001 | 0.00 | 0.00 |
| 17 | 0.18 | 3.25 | 0.08 | 0.0008 | 0.002 | 0.000 | 0.000 | 0.000 | 0.000 | 0.001 | 0.00 | 0.00 |
| 18 | 0.18 | 3.24 | 0.14 | 0.0002 | 0.002 | 0.001 | 0.000 | 0.000 | 0.000 | 0.003 | 0.00 | 0.00 |
| 19 | 0.18 | 3.25 | 0.10 | 0.0008 | 0.001 | 0.000 | 0.000 | 0.000 | 0.000 | 0.002 | 0.00 | 0.00 |
| 20 | 0.18 | 3.31 | 0.09 | 0.0016 | 0.002 | 0.000 | 0.000 | 0.000 | 0.000 | 0.002 | 0.03 | 0.07 |
| 21 | 0.18 | 3.19 | 0.08 | 0.0004 | 0.003 | 0.000 | 0.000 | 0.000 | 0.000 | 0.003 | 0.00 | 0.00 |
| 22 | 0.18 | 3.35 | 0.08 | 0.0009 | 0.003 | 0.000 | 0.000 | 0.000 | 0.000 | 0.004 | 0.02 | 0.02 |
| 23 | 0.18 | 3.40 | 0.09 | 0.0014 | 0.002 | 0.000 | 0.000 | 0.000 | 0.000 | 0.002 | 0.00 | 0.00 |
| 24 | 0.18 | 3.20 | 0.08 | 0.0028 | 0.002 | 0.000 | 0.000 | 0.000 | 0.000 | 0.004 | 0.00 | 0.13 |
| 25 | 0.18 | 3.17 | 0.13 | 0.0014 | 0.002 | 0.000 | 0.000 | 0.000 | 0.000 | 0.005 | 0.08 | 0.00 |
| 26 | 0.18 | 3.00 | 0.15 | 0.0028 | 0.002 | 0.000 | 0.000 | 0.000 | 0.000 | 0.002 | 0.00 | 0.09 |
| 27 | 0.18 | 3.19 | 0.04 | 0.0010 | 0.001 | 0.000 | 0.000 | 0.000 | 0.000 | 0.002 | 0.15 | 0.00 |
| 28 | 0.18 | 3.18 | 0.07 | 0.0026 | 0.002 | 0.000 | 0.000 | 0.000 | 0.000 | 0.002 | 0.00 | 0.09 |
| 29 | 0.18 | 3.37 | 0.09 | 0.0025 | 0.002 | 0.000 | 0.000 | 0.000 | 0.000 | 0.003 | 0.02 | 0.00 |
| 30 | 0.18 | 3.42 | 0.08 | 0.0021 | 0.001 | 0.000 | 0.000 | 0.000 | 0.000 | 0.003 | 0.00 | 0.00 |
| 31 | 0.18 | 3.33 | 0.08 | 0.0014 | 0.000 | 0.000 | 0.000 | 0.000 | 0.000 | 0.003 | 0.00 | 0.00 |
| 32 | 0.18 | 3.39 | 0.08 | 0.0014 | 0.001 | 0.000 | 0.000 | 0.000 | 0.000 | 0.001 | 0.00 | 0.00 |
| 33 | 0.18 | 3.31 | 0.06 | 0.0010 | 0.001 | 0.000 | 0.000 | 0.000 | 0.000 | 0.001 | 0.00 | 0.00 |
| 34 | 0.18 | 3.24 | 0.04 | 0.0008 | 0.001 | 0.000 | 0.000 | 0.000 | 0.000 | 0.002 | 0.00 | 0.00 |
| 35 | 0.18 | 3.31 | 0.04 | 0.0019 | 0.001 | 0.000 | 0.000 | 0.000 | 0.000 | 0.002 | 0.00 | 0.00 |
| 36 | 0.18 | 3.32 | 0.08 | 0.0024 | 0.002 | 0.000 | 0.000 | 0.000 | 0.000 | 0.002 | 0.00 | 0.00 |
| 37 | 0.18 | 2.97 | 0.01 | 0.0014 | 0.002 | 0.000 | 0.000 | 0.000 | 0.000 | 0.002 | 0.00 | 0.00 |
| 38 | 0.18 | 3.38 | 0.05 | 0.0014 | 0.002 | 0.000 | 0.000 | 0.000 | 0.000 | 0.003 | 0.00 | 0.00 |

TABLE 2B

| | Sheet thickness | Chemical composition of grain-oriented electrical steel sheet | | | | | | | | | | |
|---|---|---|---|---|---|---|---|---|---|---|---|---|
| Steel | of product | (mass %, balance: Fe and impurities) | | | | | | | | | | |
| No. | [mm] | Si | Mn | N | C | Sol. Al | S | Se | S + Se | Ti | Ni | Cu |
| 39 | 0.18 | 3.19 | 0.07 | 0.0031 | 0.002 | 0.000 | 0.000 | 0.000 | 0.000 | 0.002 | 0.00 | 0.00 |
| 40 | 0.18 | 2.51 | 0.07 | 0.0030 | 0.001 | 0.000 | 0.000 | 0.000 | 0.000 | 0.002 | 0.00 | 0.00 |
| 41 | 0.18 | 3.43 | 0.08 | 0.0024 | 0.001 | 0.000 | 0.000 | 0.000 | 0.000 | 0.001 | 0.00 | 0.00 |
| 42 | 0.18 | 3.21 | 0.22 | 0.0014 | 0.002 | 0.000 | 0.000 | 0.000 | 0.000 | 0.002 | 0.00 | 0.00 |
| 43 | 0.18 | 3.19 | 0.06 | 0.0011 | 0.001 | 0.000 | 0.000 | 0.000 | 0.000 | 0.002 | 0.00 | 0.00 |
| 44 | 0.18 | 3.43 | 0.10 | 0.0014 | 0.001 | 0.000 | 0.000 | 0.000 | 0.000 | 0.002 | 0.00 | 0.00 |
| 45 | 0.18 | 3.29 | 0.04 | 0.0021 | 0.002 | 0.000 | 0.000 | 0.000 | 0.000 | 0.003 | 0.00 | 0.00 |
| 46 | 0.18 | 3.21 | 0.09 | 0.0020 | 0.001 | 0.000 | 0.000 | 0.000 | 0.000 | 0.002 | 0.00 | 0.00 |
| 47 | 0.18 | 3.25 | 0.14 | 0.0024 | 0.002 | 0.000 | 0.000 | 0.000 | 0.000 | 0.004 | 0.00 | 0.00 |
| 48 | 0.18 | 3.43 | 0.09 | 0.0018 | 0.001 | 0.000 | 0.000 | 0.000 | 0.000 | 0.002 | 0.00 | 0.00 |
| 49 | 0.18 | 3.41 | 0.10 | 0.0014 | 0.001 | 0.000 | 0.000 | 0.000 | 0.000 | 0.001 | 0.00 | 0.00 |
| 50 | 0.18 | 3.51 | 0.08 | 0.0022 | 0.001 | 0.000 | 0.000 | 0.000 | 0.000 | 0.002 | 0.00 | 0.00 |
| 51 | 0.18 | 3.23 | 0.07 | 0.0012 | 0.001 | 0.000 | 0.000 | 0.000 | 0.000 | 0.002 | 0.00 | 0.06 |
| 52 | 0.18 | 3.16 | 0.08 | 0.0015 | 0.001 | 0.000 | 0.000 | 0.000 | 0.000 | 0.002 | 0.02 | 0.04 |
| 53 | 0.18 | 3.75 | 0.08 | 0.0019 | 0.001 | 0.000 | 0.000 | 0.000 | 0.000 | 0.002 | 0.00 | 0.00 |
| 54 | 0.18 | 3.18 | 0.18 | 0.0012 | 0.001 | 0.000 | 0.000 | 0.000 | 0.000 | 0.006 | 0.01 | 0.07 |
| 55 | 0.18 | 3.41 | 0.04 | 0.0014 | 0.001 | 0.000 | 0.000 | 0.000 | 0.000 | 0.004 | 0.00 | 0.00 |
| 56 | 0.18 | 3.42 | 0.06 | 0.0009 | 0.002 | 0.001 | 0.001 | 0.000 | 0.001 | 0.003 | 0.00 | 0.00 |
| 57 | 0.18 | 3.09 | 0.01 | 0.0010 | 0.002 | 0.000 | 0.000 | 0.000 | 0.000 | 0.006 | 0.04 | 0.00 |
| 58 | 0.18 | 2.81 | 0.09 | 0.0009 | 0.002 | 0.000 | 0.000 | 0.000 | 0.000 | 0.002 | 0.00 | 0.00 |
| 59 | 0.18 | 3.95 | 0.08 | 0.0014 | 0.002 | 0.000 | 0.000 | 0.000 | 0.000 | 0.001 | 0.01 | 0.00 |
| 60 | 0.18 | 2.51 | 0.08 | 0.0012 | 0.001 | 0.000 | 0.000 | 0.000 | 0.000 | 0.001 | 0.00 | 0.06 |
| 61 | 0.18 | 2.97 | 0.29 | 0.0009 | 0.002 | 0.000 | 0.000 | 0.000 | 0.000 | 0.002 | 0.00 | 0.00 |
| 62 | 0.18 | 3.24 | 0.21 | 0.0004 | 0.001 | 0.000 | 0.000 | 0.000 | 0.000 | 0.002 | 0.00 | 0.14 |
| 63 | 0.18 | 3.21 | 0.08 | 0.0014 | 0.001 | 0.000 | 0.000 | 0.000 | 0.000 | 0.001 | 0.02 | 0.05 |
| 64 | 0.18 | 3.33 | 0.07 | 0.0022 | 0.001 | 0.000 | 0.000 | 0.000 | 0.000 | 0.002 | 0.00 | 0.00 |
| 65 | 0.18 | 3.50 | 0.04 | 0.0021 | 0.001 | 0.000 | 0.000 | 0.000 | 0.000 | 0.002 | 0.04 | 0.04 |
| 66 | 0.18 | 3.45 | 0.11 | 0.0018 | 0.001 | 0.000 | 0.000 | 0.000 | 0.000 | 0.004 | 0.00 | 0.07 |
| 67 | 0.18 | 3.40 | 0.16 | 0.0009 | 0.001 | 0.000 | 0.000 | 0.000 | 0.000 | 0.002 | 0.09 | 0.00 |
| 68 | 0.18 | 2.98 | 0.14 | 0.0021 | 0.001 | 0.000 | 0.000 | 0.000 | 0.000 | 0.001 | 0.02 | 0.00 |
| 69 | 0.18 | 3.18 | 0.12 | 0.0014 | 0.001 | 0.000 | 0.000 | 0.000 | 0.000 | 0.001 | 0.00 | 0.07 |
| 70 | 0.18 | 3.40 | 0.05 | 0.0015 | 0.001 | 0.000 | 0.000 | 0.000 | 0.000 | 0.002 | 0.00 | 0.00 |
| 71 | 0.20 | 3.21 | 0.08 | 0.0012 | 0.001 | 0.000 | 0.000 | 0.000 | 0.000 | 0.002 | 0.00 | 0.09 |
| 72 | 0.20 | 3.17 | 0.07 | 0.0019 | 0.001 | 0.001 | 0.000 | 0.000 | 0.000 | 0.003 | 0.11 | 0.07 |
| 73 | 0.20 | 3.32 | 0.08 | 0.0015 | 0.001 | 0.001 | 0.000 | 0.000 | 0.000 | 0.002 | 0.04 | 0.03 |
| 74 | 0.23 | 3.31 | 0.08 | 0.0014 | 0.001 | 0.001 | 0.000 | 0.000 | 0.000 | 0.002 | 0.00 | 0.00 |
| 75 | 0.23 | 3.41 | 0.08 | 0.0012 | 0.002 | 0.001 | 0.000 | 0.000 | 0.000 | 0.001 | 0.02 | 0.05 |
| 76 | 0.23 | 3.38 | 0.07 | 0.0013 | 0.001 | 0.000 | 0.000 | 0.000 | 0.000 | 0.003 | 0.00 | 0.08 |

TABLE 2C

| | Chemical composition of grain-oriented electrical steel sheet | | | | | | | | | | |
|---|---|---|---|---|---|---|---|---|---|---|---|
| Steel | (mass %, balance: Fe and impurities) | | | | | | | | | | |
| No. | Sb | Sn | Cr | P | Mo | Ta | Nb | V | B | Bi | Te |
| 1 | 0.00 | 0.00 | 0.00 | 0.00 | 0.00 | 0.00 | 0.000 | 0.00 | 0.000 | 0.0000 | 0.0000 |
| 2 | 0.00 | 0.00 | 0.00 | 0.00 | 0.00 | 0.00 | 0.000 | 0.00 | 0.000 | 0.0000 | 0.0000 |
| 3 | 0.00 | 0.00 | 0.00 | 0.00 | 0.00 | 0.00 | 0.000 | 0.00 | 0.000 | 0.0000 | 0.0000 |
| 4 | 0.00 | 0.00 | 0.00 | 0.00 | 0.00 | 0.00 | 0.000 | 0.00 | 0.000 | 0.0000 | 0.0000 |
| 5 | 0.00 | 0.00 | 0.00 | 0.00 | 0.00 | 0.00 | 0.000 | 0.00 | 0.000 | 0.0000 | 0.0000 |
| 6 | 0.00 | 0.00 | 0.00 | 0.00 | 0.00 | 0.00 | 0.000 | 0.00 | 0.000 | 0.0000 | 0.0000 |
| 7 | 0.00 | 0.00 | 0.00 | 0.00 | 0.00 | 0.00 | 0.000 | 0.00 | 0.000 | 0.0000 | 0.0000 |
| 8 | 0.00 | 0.00 | 0.00 | 0.00 | 0.00 | 0.00 | 0.000 | 0.00 | 0.000 | 0.0000 | 0.0000 |
| 9 | 0.00 | 0.00 | 0.00 | 0.00 | 0.00 | 0.00 | 0.000 | 0.00 | 0.000 | 0.0000 | 0.0000 |
| 10 | 0.00 | 0.00 | 0.00 | 0.00 | 0.00 | 0.00 | 0.000 | 0.00 | 0.000 | 0.0000 | 0.0000 |
| 11 | 0.00 | 0.00 | 0.00 | 0.00 | 0.00 | 0.00 | 0.000 | 0.00 | 0.000 | 0.0000 | 0.0000 |
| 12 | 0.00 | 0.00 | 0.00 | 0.00 | 0.00 | 0.00 | 0.000 | 0.00 | 0.000 | 0.0000 | 0.0000 |
| 13 | 0.00 | 0.00 | 0.00 | 0.00 | 0.00 | 0.00 | 0.000 | 0.00 | 0.000 | 0.0000 | 0.0000 |
| 14 | 0.00 | 0.00 | 0.00 | 0.00 | 0.00 | 0.00 | 0.000 | 0.00 | 0.000 | 0.0000 | 0.0000 |
| 15 | 0.00 | 0.00 | 0.00 | 0.00 | 0.00 | 0.00 | 0.000 | 0.00 | 0.000 | 0.0000 | 0.0000 |
| 16 | 0.00 | 0.00 | 0.00 | 0.00 | 0.00 | 0.00 | 0.000 | 0.00 | 0.000 | 0.0000 | 0.0000 |
| 17 | 0.00 | 0.00 | 0.00 | 0.00 | 0.00 | 0.00 | 0.000 | 0.00 | 0.000 | 0.0000 | 0.0000 |
| 18 | 0.00 | 0.00 | 0.00 | 0.00 | 0.00 | 0.00 | 0.000 | 0.00 | 0.000 | 0.0000 | 0.0000 |
| 19 | 0.01 | 0.00 | 0.00 | 0.00 | 0.00 | 0.01 | 0.000 | 0.00 | 0.000 | 0.0000 | 0.0001 |
| 20 | 0.00 | 0.10 | 0.07 | 0.00 | 0.05 | 0.00 | 0.000 | 0.01 | 0.000 | 0.0000 | 0.0000 |
| 21 | 0.02 | 0.00 | 0.00 | 0.01 | 0.00 | 0.00 | 0.000 | 0.00 | 0.001 | 0.0000 | 0.0000 |
| 22 | 0.00 | 0.08 | 0.04 | 0.00 | 0.02 | 0.00 | 0.000 | 0.04 | 0.002 | 0.0000 | 0.0000 |
| 23 | 0.01 | 0.00 | 0.00 | 0.00 | 0.00 | 0.00 | 0.001 | 0.00 | 0.000 | 0.0000 | 0.0000 |
| 24 | 0.00 | 0.12 | 0.14 | 0.01 | 0.01 | 0.00 | 0.001 | 0.00 | 0.000 | 0.0000 | 0.0000 |
| 25 | 0.00 | 0.00 | 0.00 | 0.04 | 0.00 | 0.03 | 0.000 | 0.00 | 0.000 | 0.0002 | 0.0000 |
| 26 | 0.00 | 0.24 | 0.03 | 0.00 | 0.02 | 0.00 | 0.000 | 0.00 | 0.000 | 0.0000 | 0.0000 |
| 27 | 0.00 | 0.00 | 0.00 | 0.02 | 0.00 | 0.00 | 0.002 | 0.00 | 0.002 | 0.0000 | 0.0000 |
| 28 | 0.00 | 0.14 | 0.06 | 0.00 | 0.01 | 0.00 | 0.000 | 0.01 | 0.000 | 0.0000 | 0.0001 |
| 29 | 0.00 | 0.00 | 0.00 | 0.01 | 0.00 | 0.01 | 0.000 | 0.00 | 0.000 | 0.0000 | 0.0000 |
| 30 | 0.00 | 0.00 | 0.24 | 0.00 | 0.00 | 0.00 | 0.000 | 0.00 | 0.000 | 0.0000 | 0.0000 |
| 31 | 0.00 | 0.00 | 0.00 | 0.00 | 0.00 | 0.00 | 0.000 | 0.00 | 0.000 | 0.0000 | 0.0000 |
| 32 | 0.00 | 0.00 | 0.00 | 0.00 | 0.00 | 0.00 | 0.000 | 0.00 | 0.000 | 0.0000 | 0.0000 |
| 33 | 0.00 | 0.00 | 0.00 | 0.00 | 0.00 | 0.00 | 0.000 | 0.00 | 0.000 | 0.0000 | 0.0000 |
| 34 | 0.00 | 0.00 | 0.00 | 0.00 | 0.00 | 0.00 | 0.000 | 0.00 | 0.000 | 0.0000 | 0.0000 |
| 35 | 0.00 | 0.00 | 0.00 | 0.00 | 0.00 | 0.00 | 0.000 | 0.00 | 0.000 | 0.0000 | 0.0000 |
| 36 | 0.00 | 0.00 | 0.00 | 0.00 | 0.00 | 0.00 | 0.000 | 0.00 | 0.000 | 0.0000 | 0.0000 |
| 37 | 0.00 | 0.00 | 0.00 | 0.00 | 0.00 | 0.00 | 0.000 | 0.00 | 0.000 | 0.0000 | 0.0000 |
| 38 | 0.00 | 0.00 | 0.00 | 0.00 | 0.00 | 0.00 | 0.000 | 0.00 | 0.000 | 0.0000 | 0.0000 |

TABLE 2D

| | Chemical composition of grain-oriented electrical steel sheet | | | | | | | | | | |
|---|---|---|---|---|---|---|---|---|---|---|---|
| Steel | (mass %, balance: Fe and impurities) | | | | | | | | | | |
| No. | Sb | Sn | Cr | P | Mo | Ta | Nb | V | B | Bi | Te |
| 39 | 0.00 | 0.00 | 0.00 | 0.00 | 0.00 | 0.00 | 0.000 | 0.00 | 0.000 | 0.0000 | 0.0000 |
| 40 | 0.00 | 0.00 | 0.00 | 0.00 | 0.00 | 0.00 | 0.000 | 0.00 | 0.000 | 0.0000 | 0.0000 |
| 41 | 0.00 | 0.00 | 0.00 | 0.00 | 0.00 | 0.00 | 0.000 | 0.00 | 0.000 | 0.0000 | 0.0000 |
| 42 | 0.00 | 0.00 | 0.00 | 0.00 | 0.00 | 0.00 | 0.000 | 0.00 | 0.000 | 0.0000 | 0.0000 |
| 43 | 0.00 | 0.00 | 0.00 | 0.00 | 0.00 | 0.00 | 0.000 | 0.00 | 0.000 | 0.0000 | 0.0000 |
| 44 | 0.00 | 0.00 | 0.00 | 0.00 | 0.00 | 0.00 | 0.000 | 0.00 | 0.000 | 0.0000 | 0.0000 |
| 45 | 0.00 | 0.00 | 0.00 | 0.00 | 0.00 | 0.00 | 0.000 | 0.00 | 0.000 | 0.0000 | 0.0000 |
| 46 | 0.00 | 0.00 | 0.00 | 0.00 | 0.00 | 0.00 | 0.000 | 0.00 | 0.000 | 0.0000 | 0.0000 |
| 47 | 0.00 | 0.00 | 0.00 | 0.00 | 0.00 | 0.00 | 0.000 | 0.00 | 0.000 | 0.0000 | 0.0000 |
| 48 | 0.00 | 0.00 | 0.00 | 0.00 | 0.00 | 0.00 | 0.000 | 0.00 | 0.000 | 0.0000 | 0.0000 |
| 49 | 0.00 | 0.00 | 0.00 | 0.00 | 0.00 | 0.00 | 0.000 | 0.00 | 0.000 | 0.0000 | 0.0000 |
| 50 | 0.00 | 0.00 | 0.00 | 0.00 | 0.00 | 0.00 | 0.000 | 0.00 | 0.000 | 0.0000 | 0.0000 |
| 51 | 0.01 | 0.08 | 0.00 | 0.02 | 0.01 | 0.00 | 0.001 | 0.00 | 0.000 | 0.0000 | 0.0000 |
| 52 | 0.00 | 0.00 | 0.00 | 0.04 | 0.00 | 0.03 | 0.000 | 0.00 | 0.000 | 0.0000 | 0.0000 |
| 53 | 0.00 | 0.00 | 0.00 | 0.00 | 0.00 | 0.04 | 0.002 | 0.00 | 0.001 | 0.0000 | 0.0000 |
| 54 | 0.00 | 0.21 | 0.00 | 0.00 | 0.00 | 0.00 | 0.000 | 0.00 | 0.000 | 0.0001 | 0.0000 |
| 55 | 0.08 | 0.00 | 0.00 | 0.01 | 0.01 | 0.00 | 0.000 | 0.05 | 0.000 | 0.0000 | 0.0000 |
| 56 | 0.00 | 0.00 | 0.02 | 0.00 | 0.02 | 0.00 | 0.001 | 0.00 | 0.001 | 0.0000 | 0.0000 |
| 57 | 0.00 | 0.11 | 0.00 | 0.02 | 0.00 | 0.00 | 0.000 | 0.00 | 0.000 | 0.0001 | 0.0000 |
| 58 | 0.00 | 0.00 | 0.00 | 0.00 | 0.00 | 0.01 | 0.000 | 0.01 | 0.000 | 0.0000 | 0.0000 |
| 59 | 0.01 | 0.00 | 0.00 | 0.02 | 0.00 | 0.00 | 0.000 | 0.00 | 0.002 | 0.0000 | 0.0000 |
| 60 | 0.00 | 0.00 | 0.05 | 0.00 | 0.00 | 0.00 | 0.001 | 0.00 | 0.000 | 0.0000 | 0.0000 |
| 61 | 0.03 | 0.00 | 0.00 | 0.00 | 0.04 | 0.00 | 0.000 | 0.14 | 0.000 | 0.0000 | 0.0000 |
| 62 | 0.00 | 0.00 | 0.00 | 0.02 | 0.00 | 0.00 | 0.000 | 0.00 | 0.000 | 0.0000 | 0.0000 |
| 63 | 0.00 | 0.10 | 0.02 | 0.00 | 0.00 | 0.00 | 0.000 | 0.00 | 0.001 | 0.0000 | 0.0000 |
| 64 | 0.01 | 0.02 | 0.04 | 0.00 | 0.00 | 0.00 | 0.000 | 0.00 | 0.000 | 0.0000 | 0.0000 |
| 65 | 0.00 | 0.00 | 0.04 | 0.00 | 0.00 | 0.00 | 0.000 | 0.08 | 0.000 | 0.0000 | 0.0000 |
| 66 | 0.00 | 0.00 | 0.00 | 0.04 | 0.00 | 0.00 | 0.003 | 0.00 | 0.000 | 0.0000 | 0.0000 |
| 67 | 0.00 | 0.00 | 0.04 | 0.00 | 0.00 | 0.02 | 0.000 | 0.00 | 0.001 | 0.0000 | 0.0001 |
| 68 | 0.00 | 0.20 | 0.00 | 0.03 | 0.01 | 0.00 | 0.000 | 0.00 | 0.000 | 0.0000 | 0.0000 |
| 69 | 0.00 | 0.12 | 0.08 | 0.00 | 0.00 | 0.00 | 0.000 | 0.00 | 0.000 | 0.0000 | 0.0000 |
| 70 | 0.00 | 0.00 | 0.00 | 0.00 | 0.00 | 0.02 | 0.000 | 0.00 | 0.000 | 0.0000 | 0.0000 |
| 71 | 0.00 | 0.22 | 0.03 | 0.00 | 0.02 | 0.00 | 0.000 | 0.00 | 0.000 | 0.0001 | 0.0000 |
| 72 | 0.01 | 0.11 | 0.00 | 0.02 | 0.00 | 0.00 | 0.001 | 0.00 | 0.001 | 0.0000 | 0.0000 |
| 73 | 0.00 | 0.00 | 0.03 | 0.01 | 0.01 | 0.01 | 0.000 | 0.00 | 0.000 | 0.0000 | 0.0000 |
| 74 | 0.00 | 0.10 | 0.04 | 0.00 | 0.00 | 0.01 | 0.001 | 0.00 | 0.000 | 0.0000 | 0.0000 |
| 75 | 0.00 | 0.00 | 0.04 | 0.00 | 0.00 | 0.00 | 0.000 | 0.08 | 0.000 | 0.0000 | 0.0000 |
| 76 | 0.00 | 0.06 | 0.00 | 0.01 | 0.00 | 0.00 | 0.001 | 0.00 | 0.000 | 0.0000 | 0.0000 |

TABLE 3A

| | Sheet | Sheet | | | | | | | | | |
|---|---|---|---|---|---|---|---|---|---|---|---|
| | thickness | thickness | Cold | Laser irradiation | | | | | | | |
| | of | of | rolling | | | | | | Irradiation | Interval | Inclination |
| | cold-band | hot-band | reduction | | Up | Output | Dl | Dc | time | L | angle |
| No. | [mm] | [mm] | (%) | Laser | [J/mm²] | [W] | [mm] | [mm] | [s] | [mm] | [deg.] |
| 1 | 0.17 | 2.3 | 93 | Irradiated | 1 | 5000 | 0.5 | 100 | 0.01 | 10 | 90 |
| 2 | 0.17 | 2.4 | 93 | Irradiated | 3 | 5000 | 0.5 | 100 | 0.02 | 15 | 90 |
| 3 | 0.17 | 2.4 | 93 | Irradiated | 4 | 5000 | 0.5 | 100 | 0.03 | 15 | 80 |
| 4 | 0.17 | 2.0 | 92 | Irradiated | 5 | 5000 | 0.5 | 100 | 0.04 | 5 | 90 |
| 5 | 0.17 | 1.8 | 91 | Irradiated | 1 | 5000 | 0.5 | 100 | 0.01 | 5 | 30 |
| 6 | 0.17 | 2.3 | 93 | Irradiated | 3 | 5000 | 0.5 | 100 | 0.02 | 10 | 90 |
| 7 | 0.17 | 2.3 | 93 | Irradiated | 4 | 5000 | 0.5 | 100 | 0.03 | 30 | 90 |
| 8 | 0.17 | 2.4 | 93 | Irradiated | 1 | 5000 | 0.5 | 100 | 0.01 | 10 | 90 |
| 9 | 0.17 | 1.6 | 89 | Irradiated | 3 | 5000 | 0.5 | 100 | 0.02 | 20 | 70 |
| 10 | 0.17 | 2.0 | 92 | Irradiated | 3 | 5000 | 0.5 | 100 | 0.02 | 15 | 90 |
| 11 | 0.17 | 2.2 | 92 | Irradiated | 5 | 5000 | 0.5 | 100 | 0.04 | 30 | 90 |
| 12 | 0.17 | 2.6 | 93 | Irradiated | 3 | 5000 | 0.5 | 100 | 0.02 | 10 | 90 |
| 13 | 0.17 | 2.4 | 93 | Irradiated | 3 | 5000 | 0.5 | 100 | 0.02 | 5 | 90 |
| 14 | 0.17 | 2.3 | 93 | Irradiated | 1 | 5000 | 0.5 | 100 | 0.01 | 10 | 80 |
| 15 | 0.17 | 2.2 | 92 | Irradiated | 3 | 5000 | 0.5 | 100 | 0.02 | 5 | 90 |
| 16 | 0.17 | 1.6 | 89 | Irradiated | 1 | 5000 | 0.5 | 100 | 0.01 | 10 | 80 |
| 17 | 0.17 | 2.2 | 92 | Irradiated | 3 | 5000 | 0.5 | 100 | 0.02 | 10 | 90 |
| 18 | 0.17 | 2.3 | 93 | Irradiated | 3 | 5000 | 0.5 | 100 | 0.02 | 10 | 90 |
| 19 | 0.17 | 2.4 | 93 | Irradiated | 1 | 5000 | 0.5 | 100 | 0.01 | 5 | 50 |
| 20 | 0.17 | 2.4 | 93 | Irradiated | 3 | 5000 | 0.5 | 100 | 0.02 | 10 | 90 |
| 21 | 0.17 | 2.6 | 93 | Irradiated | 1 | 5000 | 0.5 | 100 | 0.01 | 15 | 90 |
| 22 | 0.17 | 2.4 | 93 | Irradiated | 3 | 5000 | 0.5 | 100 | 0.02 | 15 | 90 |
| 23 | 0.17 | 2.3 | 93 | Irradiated | 3 | 5000 | 0.5 | 100 | 0.02 | 10 | 70 |
| 24 | 0.17 | 2.0 | 92 | Irradiated | 5 | 5000 | 0.5 | 100 | 0.04 | 10 | 90 |
| 25 | 0.17 | 2.1 | 92 | Irradiated | 3 | 5000 | 0.5 | 100 | 0.02 | 10 | 70 |
| 26 | 0.17 | 2.3 | 93 | Irradiated | 5 | 5000 | 0.5 | 100 | 0.04 | 10 | 90 |
| 27 | 0.17 | 2.4 | 93 | Irradiated | 3 | 5000 | 0.5 | 100 | 0.02 | 30 | 90 |
| 28 | 0.17 | 2.1 | 92 | Irradiated | 3 | 5000 | 0.5 | 100 | 0.02 | 10 | 90 |
| 29 | 0.17 | 2.6 | 93 | Irradiated | 3 | 5000 | 0.5 | 100 | 0.02 | 20 | 80 |
| 30 | 0.17 | 2.5 | 93 | Irradiated | 1 | 5000 | 0.5 | 100 | 0.01 | 10 | 80 |
| 31 | 0.17 | 1.4 | 88 | Irradiated | 3 | 5000 | 0.5 | 100 | 0.02 | 10 | 70 |
| 32 | 0.17 | 2.8 | 94 | Irradiated | 5 | 5000 | 0.5 | 100 | 0.04 | 10 | 90 |
| 33 | 0.17 | 2.1 | 92 | Not | — | — | — | — | — | — | — |
| | | | | irradiated | | | | | | | |
| 34 | 0.17 | 2.3 | 93 | Not | — | — | — | — | — | — | — |
| | | | | irradiated | | | | | | | |
| 35 | 0.17 | 1.9 | 91 | Irradiated | 0 | 5000 | 0.5 | 100 | 0.00 | 10 | 90 |
| 36 | 0.17 | 2.2 | 92 | Irradiated | 6 | 5000 | 0.5 | 100 | 0.05 | 10 | 80 |
| 37 | 0.17 | 1.6 | 89 | Irradiated | 3 | 5000 | 0.5 | 100 | 0.02 | 40 | 90 |
| 38 | 0.17 | 2.3 | 93 | Irradiated | 3 | 5000 | 0.5 | 100 | 0.02 | 40 | 90 |

TABLE 3B

| | Sheet | Sheet | | | | | | | | | |
|---|---|---|---|---|---|---|---|---|---|---|---|
| | thickness | thickness | Cold | Laser irradiation | | | | | | | |
| | of | of | rolling | | | | | | Irradiation | Interval | Inclination |
| | cold-band | hot-band | reduction | | Up | Output | Dl | Dc | time | L | angle |
| No. | [mm] | [mm] | (%) | Laser | [J/mm²] | [W] | [mm] | [mm] | [s] | [mm] | [deg.] |
| 39 | 0.17 | 2.4 | 93 | Irradiated | 3 | 5000 | 0.5 | 100 | 0.02 | 10 | 20 |
| 40 | 0.17 | 2.6 | 93 | Irradiated | 1 | 5000 | 0.5 | 100 | 0.01 | 10 | 20 |
| 41 | 0.17 | 2.3 | 93 | Irradiated | 1 | 5000 | 0.5 | 100 | 0.01 | 10 | 80 |
| 42 | 0.17 | 2.2 | 92 | Irradiated | 3 | 5000 | 0.5 | 100 | 0.02 | 10 | 90 |
| 43 | 0.17 | 2.1 | 92 | Irradiated | 1 | 5000 | 0.5 | 100 | 0.01 | 10 | 90 |
| 44 | 0.17 | 2.4 | 93 | Irradiated | 2 | 5000 | 0.5 | 100 | 0.02 | 10 | 90 |
| 45 | 0.17 | 2.2 | 92 | Irradiated | 3 | 5000 | 0.5 | 100 | 0.02 | 10 | 90 |
| 46 | 0.17 | 2.2 | 92 | Irradiated | 4 | 5000 | 0.5 | 100 | 0.03 | 10 | 90 |
| 47 | 0.17 | 2.3 | 93 | Irradiated | 5 | 5000 | 0.5 | 100 | 0.04 | 10 | 90 |
| 48 | 0.17 | 1.8 | 91 | Irradiated | 5 | 5000 | 0.5 | 100 | 0.04 | 10 | 90 |
| 49 | 0.17 | 2.3 | 93 | Irradiated | 3 | 5000 | 0.5 | 100 | 0.02 | 10 | 90 |
| 50 | 0.17 | 2.4 | 93 | Irradiated | 1 | 5000 | 0.5 | 100 | 0.01 | 10 | 80 |
| 51 | 0.17 | 1.4 | 88 | Irradiated | 5 | 5000 | 0.5 | 100 | 0.04 | 10 | 90 |
| 52 | 0.17 | 2.8 | 94 | Irradiated | 3 | 5000 | 0.5 | 100 | 0.02 | 30 | 90 |
| 53 | 0.17 | 2.6 | 93 | Not | — | — | — | — | — | — | — |
| | | | | irradiated | | | | | | | |
| 54 | 0.17 | 2.2 | 92 | Not | — | — | — | — | — | — | — |
| | | | | irradiated | | | | | | | |
| 55 | 0.17 | 2.5 | 93 | Irradiated | 0 | 5000 | 0.5 | 100 | 0.00 | 10 | 90 |
| 56 | 0.17 | 2.4 | 93 | Irradiated | 6 | 5000 | 0.5 | 100 | 0.05 | 10 | 80 |
| 57 | 0.17 | 1.9 | 91 | Irradiated | 3 | 5000 | 0.5 | 100 | 0.02 | 40 | 90 |
| 58 | 0.17 | 1.6 | 89 | Irradiated | 3 | 5000 | 0.5 | 100 | 0.02 | 40 | 90 |
| 59 | 0.17 | 2.4 | 93 | Irradiated | 3 | 5000 | 0.5 | 100 | 0.02 | 10 | 20 |
| 60 | 0.17 | 2.4 | 93 | Irradiated | 1 | 5000 | 0.5 | 100 | 0.01 | 10 | 20 |
| 61 | 0.17 | 1.8 | 91 | Irradiated | 1 | 5000 | 0.5 | 100 | 0.01 | 10 | 80 |
| 62 | 0.17 | 2.3 | 93 | Irradiated | 3 | 5000 | 0.5 | 100 | 0.02 | 10 | 90 |
| 63 | 0.17 | 2.0 | 92 | Irradiated | 1 | 5000 | 0.5 | 100 | 0.01 | 10 | 90 |
| 64 | 0.17 | 2.2 | 92 | Irradiated | 2 | 5000 | 0.5 | 100 | 0.02 | 10 | 90 |
| 65 | 0.17 | 2.1 | 92 | Irradiated | 3 | 5000 | 0.5 | 100 | 0.02 | 10 | 90 |
| 66 | 0.17 | 2.4 | 93 | Irradiated | 4 | 5000 | 0.5 | 100 | 0.03 | 10 | 90 |
| 67 | 0.17 | 2.3 | 93 | Irradiated | 5 | 5000 | 0.5 | 100 | 0.04 | 10 | 90 |
| 68 | 0.17 | 2.6 | 93 | Irradiated | 5 | 5000 | 0.5 | 100 | 0.04 | 10 | 90 |
| 69 | 0.17 | 2.3 | 93 | Irradiated | 3 | 5000 | 0.5 | 100 | 0.02 | 10 | 90 |
| 70 | 0.17 | 2.5 | 93 | Irradiated | 1 | 5000 | 0.5 | 100 | 0.01 | 10 | 80 |
| 71 | 0.19 | 1.8 | 89 | Irradiated | 3 | 5000 | 0.5 | 100 | 0.02 | 10 | 90 |
| 72 | 0.19 | 2.3 | 92 | Irradiated | 3 | 5000 | 0.5 | 100 | 0.02 | 10 | 90 |
| 73 | 0.19 | 2.6 | 93 | Irradiated | 3 | 5000 | 0.5 | 100 | 0.02 | 10 | 90 |
| 74 | 0.22 | 2.0 | 89 | Irradiated | 3 | 5000 | 0.5 | 100 | 0.02 | 10 | 90 |
| 75 | 0.22 | 2.5 | 91 | Irradiated | 3 | 5000 | 0.5 | 100 | 0.02 | 10 | 90 |
| 76 | 0.22 | 3.0 | 93 | Irradiated | 3 | 5000 | 0.5 | 100 | 0.02 | 10 | 90 |

TABLE 3C

| | Temperature rising rate of | Oxygen potential of heat | | | |
|---|---|---|---|---|---|
| | temperature rising process | equalizing process of | | | |
| | of decarburization | decarburization annealing step | | | |
| | annealing | | Lower | Upper | Deter- |
| No. | step V [° C./sec] | Po | limit | limit | mination |
| 1 | 80 | 0.42 | 0.30 | 0.55 | ◯ |
| 2 | 80 | 0.45 | 0.30 | 0.50 | ◯ |
| 3 | 100 | 0.32 | 0.30 | 0.45 | ◯ |
| 4 | 100 | 0.33 | 0.30 | 0.40 | ◯ |
| 5 | 200 | 0.50 | 0.30 | 0.55 | ◯ |
| 6 | 200 | 0.30 | 0.30 | 0.50 | ◯ |
| 7 | 400 | 0.44 | 0.30 | 0.45 | ◯ |
| 8 | 400 | 0.44 | 0.30 | 0.55 | ◯ |
| 9 | 800 | 0.45 | 0.30 | 0.50 | ◯ |
| 10 | 800 | 0.44 | 0.30 | 0.50 | ◯ |
| 11 | 1000 | 0.34 | 0.30 | 0.40 | ◯ |
| 12 | 1000 | 0.32 | 0.30 | 0.50 | ◯ |
| 13 | 1400 | 0.45 | 0.30 | 0.50 | ◯ |
| 14 | 1400 | 0.45 | 0.30 | 0.55 | ◯ |
| 15 | 1600 | 0.45 | 0.30 | 0.50 | ◯ |
| 16 | 1600 | 0.45 | 0.30 | 0.55 | ◯ |
| 17 | 2000 | 0.38 | 0.30 | 0.50 | ◯ |
| 18 | 2000 | 0.32 | 0.30 | 0.50 | ◯ |
| 19 | 80 | 0.49 | 0.30 | 0.55 | ◯ |
| 20 | 80 | 0.33 | 0.30 | 0.50 | ◯ |
| 21 | 100 | 0.44 | 0.30 | 0.55 | ◯ |
| 22 | 100 | 0.42 | 0.30 | 0.50 | ◯ |
| 23 | 400 | 0.45 | 0.30 | 0.50 | ◯ |
| 24 | 400 | 0.33 | 0.30 | 0.40 | ◯ |
| 25 | 1000 | 0.45 | 0.30 | 0.50 | ◯ |
| 26 | 1000 | 0.33 | 0.30 | 0.40 | ◯ |
| 27 | 1600 | 0.45 | 0.30 | 0.50 | ◯ |
| 28 | 1600 | 0.42 | 0.30 | 0.50 | ◯ |
| 29 | 2000 | 0.41 | 0.30 | 0.50 | ◯ |
| 30 | 2000 | 0.41 | 0.30 | 0.55 | ◯ |
| 31 | 1000 | 0.42 | 0.30 | 0.50 | ◯ |
| 32 | 1000 | 0.39 | 0.30 | 0.40 | ◯ |
| 33 | 50 | 0.38 | 0.30 | 0.60 | ◯ |
| 34 | 1000 | 0.31 | 0.30 | 0.60 | ◯ |
| 35 | 150 | 0.48 | 0.30 | 0.60 | ◯ |
| 36 | 1400 | 0.34 | 0.30 | 0.35 | ◯ |
| 37 | 400 | 0.38 | 0.30 | 0.50 | ◯ |
| 38 | 800 | 0.42 | 0.30 | 0.50 | ◯ |

TABLE 3D

| | Temperature | | | | |
|---|---|---|---|---|---|
| | rising rate of | | | | |
| | temperature | | | | |
| | rising process | | | | |
| | of decar- | Oxygen potential of | | | |
| | burization | heat equalizing process | | | |
| | annealing | of decarburization annealing step | | | |
| | step V | | Lower | Upper | Deter- |
| No. | [° C./sec] | Po | limit | limit | mination |
| 39 | 800 | 0.45 | 0.30 | 0.50 | ◯ |
| 40 | 1400 | 0.5 | 0.30 | 0.55 | ◯ |
| 41 | 70 | 0.38 | 0.30 | 0.55 | ◯ |
| 42 | 2100 | 0.42 | 0.30 | 0.50 | ◯ |
| 43 | 400 | 0.6 | 0.30 | 0.55 | Upper limit x |
| 44 | 100 | 0.55 | 0.30 | 0.52 | Upper limit x |
| 45 | 800 | 0.52 | 0.30 | 0.50 | Upper limit x |
| 46 | 600 | 0.48 | 0.30 | 0.45 | Upper limit x |
| 47 | 100 | 0.42 | 0.30 | 0.40 | Upper limit x |
| 48 | 600 | 0.29 | 0.30 | 0.40 | Lower limit x |
| 49 | 800 | 0.24 | 0.30 | 0.50 | Lower limit x |
| 50 | 400 | 0.24 | 0.30 | 0.55 | Lower limit x |
| 51 | 1000 | 0.33 | 0.30 | 0.40 | ◯ |
| 52 | 1600 | 0.45 | 0.30 | 0.50 | ◯ |
| 53 | 50 | 0.38 | 0.30 | 0.60 | ◯ |
| 54 | 1000 | 0.31 | 0.30 | 0.60 | ◯ |
| 55 | 150 | 0.48 | 0.30 | 0.60 | ◯ |
| 56 | 1400 | 0.32 | 0.30 | 0.35 | ◯ |
| 57 | 400 | 0.38 | 0.30 | 0.50 | ◯ |
| 58 | 800 | 0.42 | 0.30 | 0.50 | ◯ |
| 59 | 800 | 0.45 | 0.30 | 0.50 | ◯ |
| 60 | 1400 | 0.5 | 0.30 | 0.55 | ◯ |
| 61 | 70 | 0.31 | 0.30 | 0.55 | ◯ |
| 62 | 2100 | 0.38 | 0.30 | 0.50 | ◯ |
| 63 | 400 | 0.57 | 0.30 | 0.55 | Upper limit x |
| 64 | 100 | 0.54 | 0.30 | 0.52 | Upper limit x |
| 65 | 800 | 0.53 | 0.30 | 0.50 | Upper limit x |
| 66 | 600 | 0.53 | 0.30 | 0.45 | Upper limit x |
| 67 | 100 | 0.45 | 0.30 | 0.40 | Upper limit x |
| 68 | 600 | 0.26 | 0.30 | 0.40 | Lower limit x |
| 69 | 800 | 0.24 | 0.30 | 0.50 | Lower limit x |
| 70 | 400 | 0.29 | 0.30 | 0.55 | Lower limit x |
| 71 | 400 | 0.3 | 0.30 | 0.50 | ◯ |
| 72 | 100 | 0.45 | 0.30 | 0.50 | ◯ |
| 73 | 1000 | 0.45 | 0.30 | 0.50 | ◯ |
| 74 | 200 | 0.49 | 0.30 | 0.50 | ◯ |
| 75 | 600 | 0.42 | 0.30 | 0.50 | ◯ |
| 76 | 1600 | 0.45 | 0.30 | 0.50 | ◯ |

TABLE 3E

| | Coil center portion (center portion) | | | | Coil end portion (outer peripheral portion) | | | | |
|---|---|---|---|---|---|---|---|---|---|
| | Magnetic | Abundance | Bending | | Magnetic | Abundance | Bending | | |
| | flux | ratio of | peeling | | flux | ratio of | peeling | | |
| | density | {211}<011> | diameter | Iomin/ | density | (211}<011> | diameter | Iomin/ | |
| No. | B8 [T] | R [%] | [mm] | Iomax | B8 [T] | R [%] | [mm] | Iomax | Note |
| 1 | 1.929 | 3 | 20 | 0.91 | 1.906 | 5 | 20 | 0.93 | Invention Example |
| 2 | 1.924 | 3 | 20 | 0.88 | 1.904 | 5 | 20 | 0.85 | Invention Example |
| 3 | 1.911 | 4 | 30 | 0.90 | 1.912 | 4 | 30 | 0.87 | Invention Example |
| 4 | 1.935 | 2 | 30 | 0.86 | 1.922 | 3 | 30 | 0.88 | Invention Example |
| 5 | 1.944 | 1 | 30 | 0.87 | 1.924 | 3 | 30 | 0.86 | Invention Example |
| 6 | 1.921 | 3 | 30 | 0.96 | 1.909 | 4 | 30 | 0.96 | Invention Example |
| 7 | 1.914 | 4 | 20 | 0.85 | 1.902 | 5 | 20 | 0.86 | Invention Example |
| 8 | 1.924 | 3 | 20 | 0.89 | 1.904 | 5 | 20 | 0.90 | Invention Example |
| 9 | 1.949 | 0 | 20 | 0.85 | 1.932 | 2 | 20 | 0.88 | Invention Example |
| 10 | 1.929 | 2 | 20 | 0.92 | 1.921 | 4 | 20 | 0.88 | Invention Example |
| 11 | 1.943 | 1 | 30 | 0.91 | 1.906 | 5 | 30 | 0.87 | Invention Example |
| 12 | 1.933 | 2 | 30 | 0.95 | 1.908 | 4 | 30 | 0.94 | Invention Example |
| 13 | 1.922 | 3 | 20 | 0.91 | 1.922 | 4 | 20 | 0.89 | Invention Example |
| 14 | 1.923 | 3 | 20 | 0.89 | 1.904 | 5 | 20 | 0.88 | Invention Example |
| 15 | 1.935 | 2 | 20 | 0.88 | 1.915 | 4 | 20 | 0.88 | Invention Example |
| 16 | 1.954 | 0 | 20 | 0.93 | 1.934 | 2 | 20 | 0.92 | Invention Example |
| 17 | 1.934 | 2 | 20 | 0.91 | 1.902 | 5 | 20 | 0.92 | Invention Example |
| 18 | 1.929 | 2 | 20 | 0.94 | 1.908 | 5 | 20 | 0.96 | Invention Example |
| 19 | 1.936 | 2 | 20 | 0.92 | 1.918 | 4 | 20 | 0.89 | Invention Example |
| 20 | 1.941 | 2 | 20 | 0.90 | 1.914 | 4 | 20 | 0.93 | Invention Example |
| 21 | 1.939 | 2 | 20 | 0.93 | 1.903 | 5 | 20 | 0.91 | Invention Example |
| 22 | 1.924 | 3 | 20 | 0.90 | 1.905 | 5 | 20 | 0.89 | Invention Example |
| 23 | 1.920 | 3 | 20 | 0.87 | 1.911 | 5 | 20 | 0.87 | Invention Example |
| 24 | 1.945 | 1 | 20 | 0.87 | 1.908 | 4 | 20 | 0.90 | Invention Example |
| 25 | 1.936 | 2 | 20 | 0.89 | 1.920 | 4 | 20 | 0.85 | Invention Example |
| 26 | 1.937 | 2 | 20 | 0.86 | 1.911 | 5 | 20 | 0.86 | Invention Example |
| 27 | 1.924 | 3 | 20 | 0.89 | 1.911 | 4 | 20 | 0.86 | Invention Example |
| 28 | 1.936 | 2 | 20 | 0.92 | 1.922 | 3 | 20 | 0.88 | Invention Example |
| 29 | 1.928 | 3 | 20 | 0.91 | 1.916 | 4 | 20 | 0.90 | Invention Example |
| 30 | 1.935 | 2 | 20 | 0.94 | 1.904 | 5 | 20 | 0.94 | Invention Example |
| 31 | 1.898 | 0 | 20 | 0.91 | 1.889 | 0 | 20 | 0.91 | Comparative Example |
| 32 | 1.770 | 13 | 20 | 0.85 | 1.765 | 15 | 20 | 0.88 | Comparative Example |
| 33 | 1.584 | — | — | — | 1.620 | — | — | — | Comparative Example |
| 34 | 1.765 | 11 | 20 | 0.98 | 1.802 | 14 | 30 | 0.98 | Comparative Example |
| 35 | 1.842 | 11 | 20 | 0.97 | 1.765 | 15 | 20 | 0.97 | Comparative Example |
| 36 | 1.873 | 3 | 20 | 0.86 | 1.912 | 4 | 20 | 0.86 | Comparative Example |
| 37 | 1.802 | 12 | 20 | 0.90 | 1.801 | 13 | 20 | 0.93 | Comparative Example |
| 38 | 1.810 | 10 | 20 | 0.92 | 1.785 | 14 | 30 | 0.90 | Comparative Example |

TABLE 3F

| | Coil center portion (center portion) | | | | Coil end portion (outer peripheral portion) | | | | |
|---|---|---|---|---|---|---|---|---|---|
| | Magnetic | Abundance | Bending | | Magnetic | Abundance | Bending | | |
| | flux | ratio of | peeling | | flux | ratio of | peeling | | |
| | density | {211}<011> | diameter | Iomin/ | density | {211}<011> | diameter | Iomin/ | |
| No. | B8 [T] | R [%] | [mm] | Iomax | B8 [T] | R [%] | [mm] | Iomax | Note |
| 39 | 1.894 | 3 | 20 | 0.86 | 1.867 | 5 | 30 | 0.85 | Comparative Example |
| 40 | 1.899 | 4 | 30 | 0.88 | 1.901 | 5 | 30 | 0.86 | Comparative Example |
| 41 | 1.687 | — | — | — | 1.555 | — | — | — | Comparative Example |
| 42 | 1.901 | 3 | 30 | 0.88 | 1.903 | 4 | 20 | 0.90 | Comparative Example |
| 43 | 1.924 | 3 | 50 | 0.81 | 1.915 | 4 | 50 | 0.78 | Comparative Example |
| 44 | 1.921 | 3 | 50 | 0.80 | 1.904 | 4 | 40 | 0.83 | Comparative Example |
| 45 | 1.937 | 2 | 40 | 0.83 | 1.903 | 5 | 40 | 0.84 | Comparative Example |
| 46 | 1.926 | 3 | 40 | 0.83 | 1.912 | 4 | 40 | 0.83 | Comparative Example |
| 47 | 1.928 | 3 | 40 | 0.84 | 1.910 | 4 | 40 | 0.84 | Comparative Example |
| 48 | 1.935 | 2 | 40 | 0.99 | 1.911 | 4 | 50 | 0.98 | Comparative Example |
| 49 | 1.919 | 3 | 50 | 0.97 | 1.907 | 4 | 50 | 0.98 | Comparative Example |
| 50 | 1.908 | 4 | 50 | 0.98 | 1.905 | 5 | 50 | 0.98 | Comparative Example |
| 51 | 1.899 | 0 | 20 | 0.86 | 1.901 | 0 | 20 | 0.88 | Comparative Example |
| 52 | 1.760 | 15 | 30 | 0.87 | 1.810 | 16 | 20 | 0.88 | Comparative Example |
| 53 | 1.551 | — | — | — | 1.528 | — | — | — | Comparative Example |
| 54 | 1.793 | 13 | 20 | 0.98 | 1.769 | 14 | 30 | 0.97 | Comparative Example |
| 55 | 1.820 | 11 | 20 | 0.97 | 1.799 | 13 | 30 | 0.97 | Comparative Example |
| 56 | 1.891 | 3 | 20 | 0.85 | 1.908 | 5 | 30 | 0.88 | Comparative Example |
| 57 | 1.822 | 9 | 30 | 0.90 | 1.821 | 13 | 30 | 0.89 | Comparative Example |
| 58 | 1.821 | 12 | 30 | 0.90 | 1.766 | 15 | 30 | 0.92 | Comparative Example |
| 59 | 1.884 | 3 | 30 | 0.86 | 1.915 | 5 | 30 | 0.90 | Comparative Example |
| 60 | 1.886 | 4 | 20 | 0.88 | 1.926 | 4 | 20 | 0.89 | Comparative Example |
| 61 | 1.567 | — | — | — | 1.624 | — | — | — | Comparative Example |
| 62 | 1.922 | 3 | 20 | 0.91 | 1.918 | 5 | 30 | 0.91 | Comparative Example |
| 63 | 1.934 | 2 | 40 | 0.84 | 1.903 | 5 | 40 | 0.84 | Comparative Example |
| 64 | 1.932 | 2 | 50 | 0.79 | 1.903 | 5 | 40 | 0.83 | Comparative Example |
| 65 | 1.926 | 3 | 50 | 0.81 | 1.916 | 4 | 40 | 0.84 | Comparative Example |
| 66 | 1.941 | 2 | 40 | 0.83 | 1.918 | 4 | 50 | 0.80 | Comparative Example |
| 67 | 1.943 | 2 | 40 | 0.84 | 1.910 | 4 | 40 | 0.84 | Comparative Example |
| 68 | 1.919 | 3 | 50 | 0.97 | 1.902 | 5 | 50 | 0.98 | Comparative Example |
| 69 | 1.924 | 3 | 50 | 0.98 | 1.904 | 5 | 40 | 0.98 | Comparative Example |
| 70 | 1.920 | 3 | 40 | 0.98 | 1.907 | 5 | 50 | 0.98 | Comparative Example |
| 71 | 1.949 | 0 | 20 | 0.96 | 1.945 | 1 | 20 | 0.96 | Invention Example |
| 72 | 1.932 | 2 | 20 | 0.88 | 1.923 | 3 | 20 | 0.88 | Invention Example |
| 73 | 1.922 | 3 | 30 | 0.87 | 1.911 | 4 | 20 | 0.88 | Invention Example |
| 74 | 1.958 | 0 | 20 | 0.85 | 1.950 | 1 | 20 | 0.84 | Invention Example |
| 75 | 1.945 | 1 | 30 | 0.88 | 1.926 | 3 | 30 | 0.90 | Invention Example |
| 76 | 1.928 | 3 | 20 | 0.88 | 1.911 | 4 | 20 | 0.88 | Invention Example |

### INDUSTRIAL APPLICABILITY

According to the above embodiments of the present invention, it is possible to obtain a grain-oriented electrical steel sheet excellent in magnetic characteristics and coating adhesion. Therefore, the obtained grain-oriented electrical steel sheet can be suitably applied to an iron core material of a transformer, and thus has high industrial applicability.

1. A grain-oriented electrical steel sheet comprising: a base steel sheet; a primary coating formed on the base steel sheet; and a secondary coating formed on the primary coating, wherein
the base steel sheet includes, as a chemical composition, in terms of mass %,
2.50 to 4.00% of Si,
0.01 to 0.30% of Mn,
0.0001 to 0.0100% of N,
0.0005 to 0.010% of C,
0 to 0.010% of sol. Al,
0 to 0.010% in total of at least one of S and Se,
0.001 to 0.010% of Ti,
0 to 0.50% of Ni,
0 to 0.50% of Cu,
0 to 0.30% of Sb,
0 to 0.30% of Sn,
0 to 0.50% of Cr,
0 to 0.05% of P,
0 to 0.05% of Mo,
0 to 0.05% of Ta,
0 to 0.010% of Nb,
0 to 0.50% of V,
0 to 0.010% of B,
0 to 0.0100% of Bi,
0 to 0.0100% of Te, and
a balance including Fe and impurities,
the grain-oriented electrical steel sheet has a magnetic flux density B8 of 1.902 T or more,
when measurement points for crystal orientation by an X-ray diffraction method are arranged on a surface of the base steel sheet at a pitch of 6 mm in each of a rolling direction and a direction orthogonal to the rolling direction, measurement points whose orientation difference from {211}<011> is within 15° are included in a percentage of 5% or less with respect to the total measurement points,
in a line analysis along the rolling direction by an electron probe microanalyzer, an obtained oxygen intensity profile at a surface of the primary coating periodically includes a region having a reduced oxygen intensity, and
Ioₘᵢₙ is defined as a minimum value of oxygen intensity in the region having a reduced oxygen intensity, Ioₘₐₓ is defined as a maximum value of oxygen intensity in a region other than the region having a reduced oxygen intensity, and a ratio of Ioₘᵢₙ/Ioₘₐₓ is 0.85 or more and 0.96 or less.

2. The grain-oriented electrical steel sheet according to claim 1, wherein the region having a reduced oxygen intensity is included at an interval L of 5 to 30 mm.

3. The grain-oriented electrical steel sheet according to claim 1, wherein the base steel sheet includes, as the chemical composition, in terms of mass %, at least one of:
0.01 to 0.50% of Ni,
0.01 to 0.50% of Cu,
0.01 to 0.30% of Sb,
0.01 to 0.30% of Sn,
0.01 to 0.50% of Cr,
0.01 to 0.05% of P,
0.01 to 0.05% of Mo,
0.01 to 0.05% of Ta,
0.001 to 0.010% of Nb,
0.01 to 0.50% of V,
0.001 to 0.010% of B,
0.0150% or less of Bi, and
0.0150% or less of Te.

4. The grain-oriented electrical steel sheet according to claim 1, having a sheet thickness of 0.15 to 0.23 mm.

5. The grain-oriented electrical steel sheet according to claim 1, wherein the base steel sheet has a sheet thickness of 0.14 to 0.22 mm.

6. A manufacturing method of a grain-oriented electrical steel sheet, the method comprising:
a hot rolling step of heating a slab and hot rolling the heated slab to obtain a hot-rolled steel sheet, the slab including, in terms of mass %,
2.50 to 4.00% of Si,
0.01 to 0.30% of Mn,
0.0030 to 0.0150% of N,
0.010 to 0.100% of C,
0.010 to 0.050% of sol. Al,
0.010 to 0.050% in total of at least one of S and Se,
0.001 to 0.010% of Ti,
0 to 0.50% of Ni,
0 to 0.50% of Cu,
0 to 0.30% of Sb,
0 to 0.30% of Sn,
0 to 0.50% of Cr,
0 to 0.05% of P,
0 to 0.05% of Mo,
0 to 0.05% of Ta,
0 to 0.010% of Nb,
0 to 0.50% of V,
0 to 0.010% of B,
0 to 0.0200% of Bi,
0 to 0.0200% of Te, and
a balance including Fe and impurities;
a hot-band annealing step of annealing the hot-rolled steel sheet;
a cold rolling step of cold rolling the hot-rolled steel sheet after the hot-band annealing step to obtain a cold-rolled steel sheet;
a decarburization annealing step of decarburization annealing the cold-rolled steel sheet to obtain a decarburization-annealed steel sheet;
a final annealing step of applying an annealing separator on the decarburization-annealed steel sheet, followed by final annealing, to form a primary coating on a surface of the decarburization-annealed steel sheet, thereby obtaining a final-annealed steel sheet; and
an insulating coating forming step of forming an insulating coating on a surface of the final-annealed steel sheet, wherein
a total rolling reduction is 89% or more in the cold rolling step,
the decarburization annealing step includes:
a local heating process of partly heating a surface of the cold-rolled steel sheet by irradiating with a laser beam in an air atmosphere at an interval of 5 to 30 mm in a direction that forms 30 to 150° with respect to a rolling direction;
a temperature rising process of raising a temperature of the cold-rolled steel sheet after the local heating process in a non-oxidizing atmosphere from a temperature range of 450° C. or lower to a temperature range of 750 to 950° C., which is a temperature for decarburization annealing, at an average heating rate of 80° C./sec or more and 2000° C./sec or less; and
a heat equalizing process of decarburization annealing the cold-rolled steel sheet after the temperature rising process at an oxygen potential P_{O} satisfying equation (1) below, when, in irradiation conditions of the laser beam in the local heating process,
an average intensity of the laser beam is defined as P, in terms of a unit of W,
a focused spot diameter of a focused spot in the rolling direction is defined as Dl, in terms of a unit of mm,
a focused spot diameter of the focused spot in a width direction orthogonal to the rolling direction is defined as Dc, in terms of a unit of mm,
an irradiation time is defined as t, in terms of a unit of sec, and
an instantaneous input energy represented by 4/π×P/(Dl×Dc)×t is defined as Up, in terms of a unit of J/mm²,
a following equation (2) is satisfied:
$${P}_{O} \leq 0.6 - 0.04 Up \qquad ( 1 )$$
$$1 \leq Up \leq 5. \qquad ( 2 )$$

7. The manufacturing method of a grain-oriented electrical steel sheet according to claim 6, wherein the slab includes, as a chemical composition, in terms of mass %, at least one of:
0.01 to 0.50% of Ni,
0.01 to 0.50% of Cu,
0.01 to 0.30% of Sb,
0.01 to 0.30% of Sn,
0.01 to 0.50% of Cr,
0.01 to 0.05% of P,
0.01 to 0.05% of Mo,
0.01 to 0.05% of Ta,
0.001 to 0.010% of Nb,
0.01 to 0.50% of V,
0.001 to 0.010% of B,
0.0100% or less of Bi, and
0.0100% or less of Te.

8. The grain-oriented electrical steel sheet according to claim 2, wherein the base steel sheet includes, as the chemical composition, in terms of mass %, at least one of:
0.01 to 0.50% of Ni,
0.01 to 0.50% of Cu,
0.01 to 0.30% of Sb,
0.01 to 0.30% of Sn,
0.01 to 0.50% of Cr,
0.01 to 0.05% of P,
0.01 to 0.05% of Mo,
0.01 to 0.05% of Ta,
0.001 to 0.010% of Nb,
0.01 to 0.50% of V,
0.001 to 0.010% of B,
0.0150% or less of Bi, and
0.0150% or less of Te.

9. The grain-oriented electrical steel sheet according to claim 2, having a sheet thickness of 0.15 to 0.23 mm.

10. The grain-oriented electrical steel sheet according to claim 2, wherein the base steel sheet has a sheet thickness of 0.14 to 0.22 mm.
